(19) United States
(12) Patent Application Publication
(10) Pub. No.: US 2025/0037734 A1
(43) Pub. Date: Jan. 30, 2025

(54) SELECTIVE PROCESSING OF SEGMENTS OF TIME-SERIES DATA BASED ON SEGMENT CLASSIFICATION

(71) Applicant: QUALCOMM Incorporated, San Diego, CA (US)

(72) Inventors: Pravin Kumar RAMADAS, San Diego, CA (US); Vivek RAJENDRAN, San Diego, CA (US)

(21) Appl. No.: 18/360,981

(22) Filed: Jul. 28, 2023

(51) Int. Cl. G10L 25/27; G10L 25/78

(52) U.S. Cl. CPC G10L 25/27; G10L 25/78

(57) ABSTRACT

A device includes a memory configured to store one or more segments of time-series data. The device also includes one or more processors configured to generate, using a feature extractor, a latent-space representation of a segment of the time-series data. The one or more processors are also configured to provide one or more inputs to a classifier, the one or more inputs including at least one input based on the latent-space representation. The one or more processors are also configured to generate, based on output of the classifier, a processing control signal for the segment.

### I. FIELD

The present disclosure is generally related to selective processing of time-series data.

### II. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

One common use for such devices includes processing of various types of time-series data, such as sensors data, audio data, video data, signals, etc. Generally, time-series data is broken down into segments for processing, and different segments can include different types of content or data. In some instances, multiple different mechanisms for processing a segment of time-series data are available, each with different advantages and disadvantages. It can be challenging to utilize multiple distinct processing operations for different types of data in a single time-series data stream if the content and/or data type of each segment of the time-series data is not known in advance.

### III. SUMMARY

According to a particular embodiment, a device includes a memory configured to store one or more segments of time-series data. The device also includes one or more processors configured to generate, using a feature extractor, a latent-space representation of a segment of the time-series data. The one or more processors are also configured to provide one or more inputs to a classifier, the one or more inputs including at least one input based on the latent-space representation. The one or more processors are also configured to generate, based on output of the classifier, a processing control signal for the segment.

According to a particular embodiment, a method includes generating, using a feature extractor, a latent-space representation of a segment of time-series data. The method also includes providing one or more inputs to a classifier, the one or more inputs including at least one input based on the latent-space representation. The method further includes generating, based on output of the classifier, a processing control signal for the segment.

According to a particular embodiment, a non-transitory computer-readable medium stores instructions that are executable by one or more processors to cause the one or more processors to generate, using a feature extractor, a latent-space representation of a segment of time-series data. The instructions further cause the one or more processors to provide one or more inputs to a classifier, the one or more inputs including at least one input based on the latent-space representation. The instructions further cause the one or more processors to generate, based on output of the classifier, a processing control signal for the segment.

According to a particular embodiment, an apparatus includes means for generating, using a feature extractor, a latent-space representation of a segment of time-series data. The apparatus also includes means for providing one or more inputs to a classifier, the one or more inputs including at least one input based on the latent-space representation. The apparatus also includes means for generating, based on output of the classifier, a processing control signal for the segment.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1A is a block diagram of a particular illustrative aspect of a system operable to selectively process time-series data in accordance with some examples of the present disclosure.

FIG. 1B is a diagram of illustrative aspects of the system of FIG. 1A in accordance with some examples of the present disclosure.

FIG. 2 is a diagram of illustrative aspects of the system of FIG. 1A in accordance with some examples of the present disclosure.

FIG. 3 is a diagram of illustrative aspects of the system of FIG. 1A in accordance with some examples of the present disclosure.

FIG. 4 is a diagram of illustrative aspects of the system of FIG. 1A in accordance with some examples of the present disclosure.

FIG. 5 is a diagram of illustrative aspects of the system of FIG. 1A in accordance with some examples of the present disclosure.

FIG. 6A illustrates aspects of training a feature extractor for use by the system of FIG. 1A in accordance with some examples of the present disclosure.

FIG. 6B illustrates aspects of training a classifier for use by the system of FIG. 1A in accordance with some examples of the present disclosure.

FIG. 7 illustrates aspects of training a feature extractor and a classifier together for use by the system of FIG. 1A in accordance with some examples of the present disclosure.

FIG. 8 is a diagram of an illustrative aspect of operation of components of the system of FIG. 1A in accordance with some examples of the present disclosure.

FIG. 9 illustrates an example of an integrated circuit operable to selectively process time-series data in accordance with some examples of the present disclosure.

FIG. 10 is a diagram of a mobile device operable to selectively process time-series data in accordance with some examples of the present disclosure.

FIG. 11 is a diagram of a headset operable to selectively process time-series data in accordance with some examples of the present disclosure.

FIG. 12 is a diagram of a wearable electronic device operable to selectively process time-series data in accordance with some examples of the present disclosure.

FIG. 13 is a diagram of an extended reality glasses device (such as virtual reality, mixed reality, or augmented reality glasses) operable to selectively process time-series data in accordance with some examples of the present disclosure.

FIG. 14 is a diagram of earbuds operable to selectively process time-series data in accordance with some examples of the present disclosure.

FIG. 15 is a diagram of a voice-controlled speaker system operable to selectively process time-series data in accordance with some examples of the present disclosure.

FIG. 16 is a diagram of a camera operable to selectively process time-series data in accordance with some examples of the present disclosure.

FIG. 17 is a diagram of an extended reality headset (such as a virtual reality, mixed reality, or augmented reality headset) operable to selectively process time-series data in accordance with some examples of the present disclosure.

FIG. 18 is a diagram of a first example of a vehicle operable to selectively process time-series data in accordance with some examples of the present disclosure.

FIG. 19 is a diagram of a second example of a vehicle operable to selectively process time-series data in accordance with some examples of the present disclosure.

FIG. 20 is a diagram of a particular embodiment of a method of selectively processing time-series data that may be performed by the device of FIG. 1A in accordance with some examples of the present disclosure.

FIG. 21 is a block diagram of a particular illustrative example of a device that is operable to selectively process time-series data in accordance with some examples of the present disclosure.

### V. DETAILED DESCRIPTION

There are many applications for processing of time-series data. Conventional examples include, without limitation, video processing, audio processing, motion processing, sensor data processing, etc. In many of these applications, the time-series data is broken down into segments for processing. For example, when the time-series data is obtained via a data stream, the data stream may be sampled periodically or occasionally to form a segment, or several such samples may be aggregated to form a segment. To illustrate, an audio signal from a microphone can be sampled periodically to generate audio data samples, and multiple such audio data samples can be aggregated to form an audio data segment (e.g., an audio frame). Similar operations can be used to form video segments, sensor data segments, etc.

After segmentation, segments of time-series data can be subjected to further processing. The specific downstream processing used for a segment depends on the specific use to which the time-series data will be put. For example, when the time-series data includes audio data or video data, segments of the time-series data may be encoded for transmission to another device (e.g., as part of a call or a media stream) or compressed for storage.

In some cases, more than one type of downstream processing could be used for a particular type of time-series data. For example, there are multiple different compression schemes available for audio data. Likewise, different encoding schemes are available for audio data. These different types of downstream processing can differ in terms of computing efficiency (e.g., processor cycles, power utilization), data efficiency (e.g., compression rate), data fidelity, and many other factors. Furthermore, some types of downstream processing may be optimized for or otherwise well suited for processing specific types of data. As one example, audio encoding schemes that work well for encoding audio data representing speech are targeted to human vocal ranges and sounds. As a result, such audio encoding schemes may be less well suited for encoding audio data representing music than an encoding scheme customized for music encoding would be.

Applying ill-suited downstream processing operations to particular time-series data may be inefficient and may result in output that does not represent the time-series data with an intended level of fidelity. This is particularly challenging when the character or content of a set of time-series data can change from time-to-time. For example, when the time-series data includes audio data representing sound captured by a microphone, the audio data may represent speech at a first time, may represent ambient sounds or noise at a second time, and may represent music at a third time.

Thus, one problem with processing time-series data is that among several different available processing options, some are better suited than others for processing particular types of content of time-series data; however, the content of any individual segment of the time-series data is generally not known in advance. Accordingly, there is a problem with selecting appropriate processing operations for particular segments of the time-series data. One solution to this problem is to apply the same processing operations to all of the time-series data. However, this solution leads to still further problems. To illustrate, certain segments may be improperly or inefficiently processed, leading to waste, rework (e.g., reprocessing of such segments), etc.

Another solution to the problem above is to analyze each segment to determine the content type of the segment so that the segment can be routed to appropriate processing operations. A problem with analyzing each segment is that performing such analyses is resource intensive, and it can be difficult to ensure that all of the possible content types have been accounted for. For example, audio data can represent a large variety of different types of sound, such as speech, music, alarms, birds, wind, waves, engines, etc. Algorithms to distinguish some of these various sound types are sometimes used (e.g., voice activity detection algorithms). However, such algorithms may not reliably distinguish among all of these sound types. Machine-learning models can be more accurate, but one or more classifiers capable of distinguishing among all of these various types of sounds would be very large, and training such classifier(s) would require use of a training data set that included labeled examples of each class. Further, if it later turned out that an important type of sound was omitted, a new classifier would need to be created and trained from scratch to account for the addition of a new class.

Aspects disclosed herein provide solutions to these, and other, problems by using low-complexity machine-learning models to analyze and classify segments of time-series data, enabling appropriate routing of each segment in an efficient manner. As one example, the machine-learning models described herein can perform real-time analysis of audio data to distinguish speech sounds from all types of non-speech sounds using fewer than 100 M floating point operations (FLOPs) (e.g., about 20-50 MFLOPs, such as 30 MFLOPs) per classification result, as compared to many other sound analysis models, which operating on the same data and hardware, would be expected to perform more than 100 MFLOPs or even more than 1000 MFLOPs, and thus impose a significant computational burden.

One way that the solutions described herein achieve such low complexity is by providing the time-series data directly to the downstream processing operations (e.g., coding operations) rather than using output of the segment classification operations for downstream processing. For example, in some embodiments, the feature extractor is configured to receive data representing an input segment, to dimensionally reduce the data, and to synthesize output data that approximately reconstructs the input segment. Since the synthesized output data is not used by the downstream processing operations, the synthesized output data can be low fidelity (e.g., low dimensionality relative to the dimensionality of a segment of the time-series data) without negatively impacting output of the downstream processing operations. Further complexity reduction is achieved in some embodiments by performing classification of the segment based on the latent-space representation, which has even lower dimensionality than the low fidelity input to the feature extractor.

In a particular aspect, a device configured to process time-series data includes a processing controller as well as one or more downstream processing components. The downstream processing component(s) are configured to perform various processing operations on the time-series data, and the processing controller is configured to generate control signals, based on analysis of segments of the time-series data, to control which processing operation(s) the downstream processing component(s) use for each segment of the time-series data. As an example, the downstream processing component(s) can include a first audio encoder (e.g., an encoder well-suited for encoding speech) and a second audio encoder (e.g., a general purpose encoder), and the processing control signals from the processing controller can cause a first set of audio data segments (e.g., segments including speech) of the time-series data to be encoded using the first audio encoder and can cause a second set of audio data segments (e.g., segments not including speech) of the time-series data to be encoded using the second audio encoder. In this example, the first set of audio data segments and the second set of audio data segments can be intermingled in the time series. For example, the first set of audio data segments can represent audio data frames that include speech and the second set of audio data segments can represent audio frames that do not include speech (e.g., include non-speech sounds).

Although audio data is used in the examples above, in other examples, the time-series data represents content other than or in addition to sound (e.g., video data, sensor data, etc.). In each of these other examples, the time-series data can be described in terms of target data and non-target data, where the target data corresponds to data for which a particular downstream processing component(s) is optimized or otherwise well suited, and the non-target data is all other data of the time-series. In some embodiments, the particular downstream processing component(s) can include targeted or special-purpose processing component(s) that are more efficient, less lossy, or otherwise better suited for processing the target data than would be a general-purpose processing component.

One challenge with controlling downstream processing in the manner described above is that there is often no way of knowing in advance which segments will be target data and which will be non-target data. In a particular aspect, the processing controller uses one or more machine-learning models to classify each segment of the time-series data (e.g., as target data or non-target data), and the processing control signal generated by the processing controller for a particular segment is based on the class assigned to the particular segment. For example, the processing controller includes a trained feature extractor and a trained classifier. In this context, “trained” indicates that at least some of the functionality of a component (e.g., a feature extractor or a classifier) is a result of machine-learning based training techniques (e.g., the functionality is learned). It can be challenging to train machine-learning model(s) to classify segments of time-series data when there are a large number of possible classes that could be assigned to the particular type of time-series data. For example, there are a large number of distinct types of sounds that audio data can represent, and training a machine-learning model to identify each of these sound types is challenging since it would require a sufficient selection of labeled training data for each class. Further, a machine-learning model trained in this way is not able to reliably classify sound types that were not included in the training data.

To address these challenges, the feature extractor of the processing controller includes an autoencoder type machine-learning model that is trained to synthesize time-series data of a target data type. To illustrate, continuing the audio example above, the feature extractor may be trained to reproduce audio data representing speech. An autoencoder trained in this manner can accurately reproduce time-series data of a type that was represented in the training data, and will be less accurate in the reproduction time-series data of types that were not represented in the training data. To illustrate, an autoencoder trained using training data representing speech may accurately reproduce or synthesize audio data representing speech and will be less accurate in reproduction of or synthesis of audio data for all types of non-speech audio. Similarly, an autoencoder trained to reproduce target time-series data will reproduce target time-series data more accurately than non-target time-series data. Further, such an autoencoder can be trained using training data that only represents the target data type, which significantly reduces the time and cost of training, and may enable use of a smaller (i.e., more memory and processor efficient) machine-learning model.

In a particular aspect, the classifier includes a machine-learning model that is trained to determine whether a particular segment of the time-series data is of a target data type or a non-target data type based at least in part on an output of the feature extractor. The output can include an intermediate or final output of the feature extractor. For example, a particular segment of the time-series data can be provided as input to an inference portion of an autoencoder to generate a latent-space representation of the particular segment, and the latent-space representation can be provided as input to a generation network portion of the autoencoder to generate synthesized data corresponding to a reproduced version of the particular segment. In this example, the latent-space representation, the synthesized data, or both can be used as the output of the autoencoder which is provided to or used to determine input to the classifier. Additionally, or alternatively, data representing network states of one or more hidden layers of the inference portion of the autoencoder or the generation network portion of the autoencoder can be used as the output.

In some embodiments, the output of the feature extractor is further processed to generate input for the classifier. For example, an error value can be determined based on differences between the synthesized data and the particular segment used to generate the synthesized data. As another example, an error value can be determined based on divergence of the latent-space representation from an expected distribution of latent-space representations representing target data.

In some embodiments, in addition to input based on the output of the feature extractor, other input may be provided to the classifier. For example, features extracted from or determined from the segment can be included among the input, such as an open loop pitch, a normalized correlation, a spectral envelope, a tonal stability, a signal non-stationarity, a linear prediction residual error, a spectral difference, a spectral stationarity, or a combination thereof, of the segment.

As another example, a mode detector that uses a light-weight (as compared to processing via the feature extractor and classifier) mode detection process can also be used to process the time-series data and a mode indicator from the mode detector can be provided as input to the classifier. To illustrate, the mode detector can include an audio mode detector that performs statistical operations to determine whether audio of the time-series data includes music. As another illustrative example, the mode detector can be configured to determine whether an audio data frame includes voiced or unvoiced speech. As another illustrative example, the mode detector can be configured to determine an Enhanced Variable Rate Codec (EVRC) mode decision based on the segment. In such embodiments, the mode detection may be based on an assumption that is not necessarily true of a particular segment of the time-series data. For example, a mode detector that generates a voice/unvoiced mode indicator may treat each segment of the time-series as though it includes speech, which may not be the case. Thus, the mode indicator generated by the mode detector is provided to the classifier, which uses the mode indicator in conjunction with other data to classify the segment as target or non-target data.

One benefit of the aspects disclosed herein is the ability to process target time-series data and non-target time-series data using different downstream processing operations without advance information about which segments of a time series include target data and which do not. Such processing can enable use of more complex or more optimized processing for certain data (e.g., target data) and less complex processing for other data (e.g., non-target data) resulting in conservation of computing resources (e.g., processor time and memory), improved processing of at least the target data of time-series data (e.g., better compression, better data fidelity, etc.) relative to using general-purpose processes for both the target and non-target data, etc.

Another benefit of the aspects disclosed herein is the ability to distinguish target data in a time series that could include a wide range of non-target data without the need for training data representing every foreseeable type of non-target data. For example, an autoencoder can be trained to reproduce the target data type using training data that only includes the data of the target data type. As a result, much less training data is needed and training time is reduced. The trained autoencoder can then be used as a feature extractor to generate feature data that is provided to relatively simple classifier (such as a one-class or binary classifier). Thus, both the feature extractor and the classifier can be relatively lightweight (e.g., as compared to a classifier trained to distinguish among a large number of classes, such as every foreseeable type of non-target data plus the target data type), resulting in conservation of computing resources (e.g., processor time and memory).

As used herein, the term “machine learning” should be understood to have any of its usual and customary meanings within the fields of computers science and data science, such meanings including, for example, processes or techniques by which one or more computers can learn to perform some operation or function without being explicitly programmed to do so. As a typical example, machine learning can be used to enable one or more computers to analyze data to identify patterns in data and generate a result based on the analysis.

For certain types of machine learning, the results that are generated include a data model (also referred to as a “machine-learning model” or simply a “model”). Typically, a model is generated using a first data set to facilitate analysis of a second data set. For example, a first portion of a large body of data may be used to generate a model that can be used to analyze the remaining portion of the large body of data. As another example, a set of historical data can be used to generate a model that can be used to analyze future data.

Since a model can be used to evaluate a set of data that is distinct from the data used to generate the model, the model can be viewed as a type of software (e.g., instructions, parameters, or both) that is automatically generated by the computer(s) during the machine learning process. As such, the model can be portable (e.g., can be generated at a first computer, and subsequently moved to a second computer for further training, for use, or both). Additionally, a model can be used in combination with one or more other models to perform a desired analysis. To illustrate, first data can be provided as input to a first model to generate first model output data, which can be provided (alone, with the first data, or with other data) as input to a second model to generate second model output data indicating a result of a desired analysis. Depending on the analysis and data involved, different combinations of models may be used to generate such results. In some examples, multiple models may provide model output that is input to a single model. In some examples, a single model provides model output to multiple models as input.

Since machine-learning models are generated by computer(s) based on input data, machine-learning models can be discussed in terms of at least two distinct time windows-a creation/training phase and a runtime phase. During the creation/training phase, a model is created, trained, adapted, validated, or otherwise configured by the computer based on the input data (which in the creation/training phase, is generally referred to as “training data”). Note that the trained model corresponds to software that has been generated and/or refined during the creation/training phase to perform particular operations, such as classification, prediction, encoding, or other data analysis or data synthesis operations. During the runtime phase (or “inference” phase), the model is used to analyze input data to generate model output. The content of the model output depends on the type of model. For example, a model can be trained to perform classification tasks or regression tasks, as non-limiting examples.

In particular embodiments, machine-learning model(s) can be trained and used on different computing devices. For example, a first computer or first set of computers can be used to train a model, and after the model is trained, the model can be executed by one or more different computers to analyze data. This portability of machine-learning model(s) means that a computing device that uses a model (e.g., at runtime) does not need to also train the model. This separation of runtime computing and training provides several benefits. For example, a model can be trained using a very large set of training data and over a large number of iterations, which uses significant computing resources, and after training, the model can be moved to a computing device with much more limited computing resources for runtime use. To illustrate, advanced computing devices, such as servers or high-end desktop computers, or a set of such computers, which have access to advanced processors, external power, and large memories, can be used to train a model. Such training is generally iterative and can entail complex calculations optimized for execution in parallel processing threads, and many memory input/output (I/O) operations. After training, the model can be moved to a more resource constrained computing device, such as a smartphone or another device with fewer computing resources (e.g., fewer or less advanced processor cores, less memory, etc.), limited power (e.g., battery power), or other limitations (e.g., heat dissipation limits). Executing the model in runtime (e.g., in the inference phase after training) is significantly less resource demanding than training. Additionally, the model can be trained at one device (or set of devices) and subsequently used essentially as software that can be copied to any number of other devices for runtime use.

Training a model based on a training data set generally involves changing parameters of the model with a goal of causing the output of the model to have particular characteristics based on data input to the model. To distinguish from model generation operations, model training may be referred to herein as optimization or optimization training. In this context, “optimization” refers to improving a metric, and does not mean finding an ideal (e.g., global maximum or global minimum) value of the metric. Examples of optimization trainers include, without limitation, backpropagation trainers, derivative free optimizers (DFOs), and extreme learning machines (ELMs). As one example of training a model, during supervised training of a neural network, an input data sample is associated with a label. When the input data sample is provided to the model, the model generates output data, which is compared to the label associated with the input data sample to generate an error value. Parameters of the model are modified in an attempt to reduce (e.g., optimize) the error value. As another example of training a model, during unsupervised training of an autoencoder, a data sample is provided as input to the autoencoder, and the autoencoder reduces the dimensionality of the data sample (which is a lossy operation) and attempts to reconstruct the data sample as output data. In this example, the output data is compared to the input data sample to generate a reconstruction loss, and parameters of the autoencoder are modified in an attempt to reduce (e.g., optimize) the reconstruction loss.

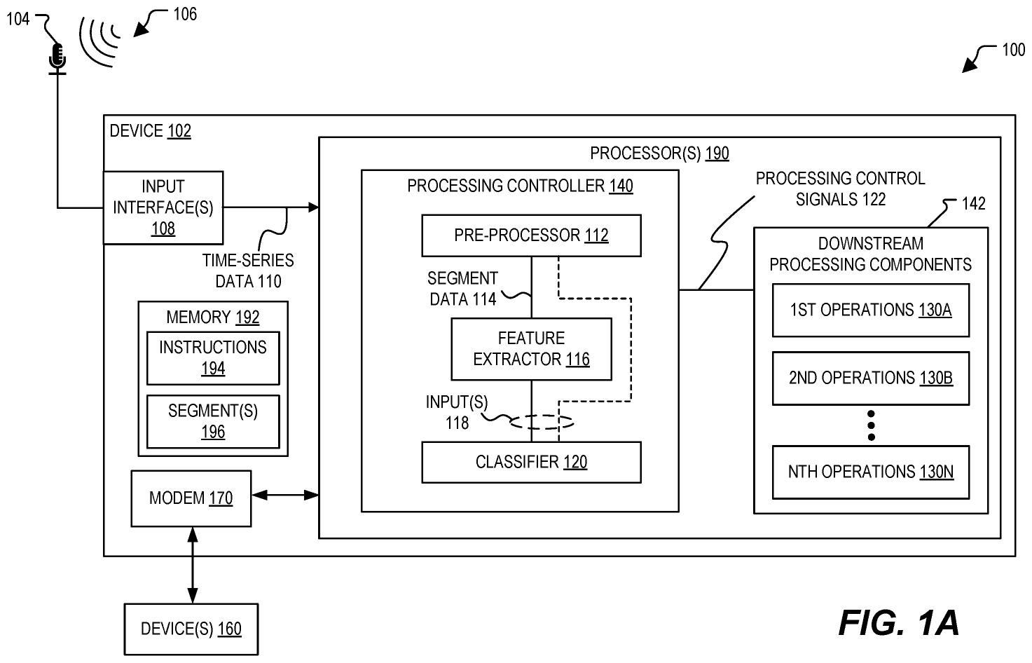

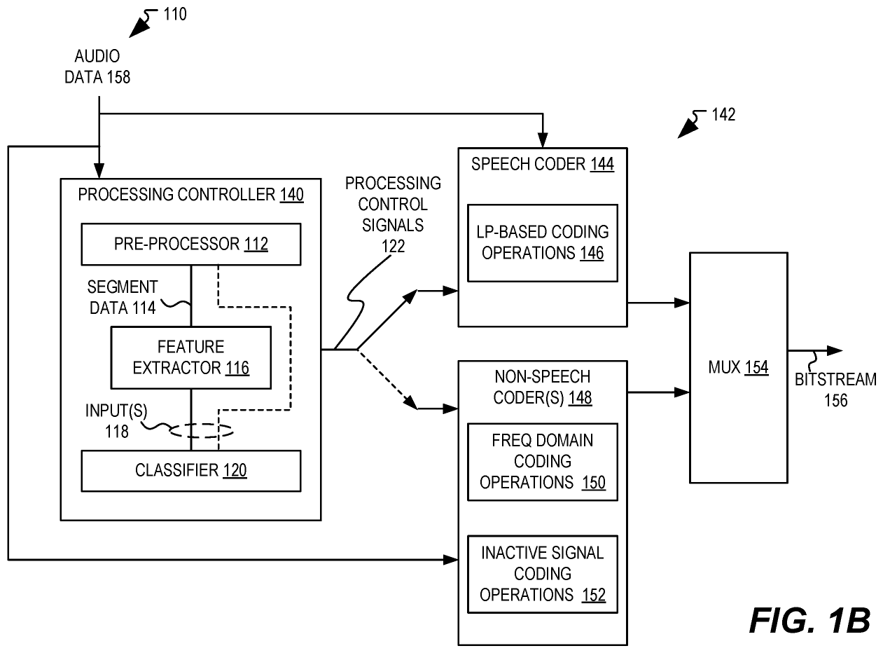

Particular aspects of the present disclosure are described below with reference to the drawings. In the description, common features are designated by common reference numbers. As used herein, various terminology is used for the purpose of describing particular embodiments only and is not intended to be limiting of embodiments. For example, the singular forms “a.” “an,” and “the” are intended to include the plural forms as well, unless the context clearly indicates otherwise. Further, some features described herein are singular in some embodiments and plural in other embodiments. To illustrate, FIG. 1A depicts a device 102 including one or more processors (“processor(s)” 190 of FIG. 1), which indicates that in some embodiments the device 102 includes a single processor 190 and in other embodiments the device 102 includes multiple processors 190. For ease of reference herein, such features are generally introduced as “one or more” features and are subsequently referred to in the singular or optional plural (as indicated by “(s)”) unless aspects related to multiple of the features are being described.

In some drawings, multiple instances of a particular type of feature are used. Although these features are physically and/or logically distinct, the same reference number is used for each, and the different instances are distinguished by addition of a letter to the reference number. When the features as a group or a type are referred to herein e.g., when no particular one of the features is being referenced, the reference number is used without a distinguishing letter. However, when one particular feature of multiple features of the same type is referred to herein, the reference number is used with the distinguishing letter. For example, referring to FIG. 1, multiple operations are illustrated and associated with reference numbers 130A, 130B, and 130N. When referring to a particular one of these operations, such as a first operation 130A, the distinguishing letter “A” is used. However, when referring to any arbitrary one of these operations or to these operations as a group, the reference number 130 is used without a distinguishing letter.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an embodiment, and/or an aspect, and should not be construed as limiting or as indicating a preference or a preferred embodiment. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled.” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some embodiments, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “determining.” “calculating.” “estimating.” “shifting.” “adjusting.” etc. may be used to describe how one or more operations are performed. It should be noted that such terms are not to be construed as limiting and other techniques may be utilized to perform similar operations. Additionally, as referred to herein, “generating.” “calculating.” “estimating.” “using.” “selecting.” “accessing.” and “determining” may be used interchangeably. For example, “generating,” “calculating.” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

Referring to FIG. 1, a particular illustrative aspect of a system configured for selective processing of time-series data is disclosed and generally designated 100. The system 100 includes a device 102 that includes one or more processors 190 and memory 192 (e.g., one or more memory devices). The device 102 includes a processing controller 140 configured to control selective processing of segments of time-series data 110. For example, the processing controller 140 is configured to generate processing control signals 122 to control which of a set of downstream processing components 142 are used to process each segment of the time-series data 110.

In some embodiments, the device 102 includes one or more input interfaces 108, and the time-series data 110 is received via the input interface(s) 108. For example, in FIG. 1, a microphone 104 is coupled to the input interface(s) 108 to receive sound 106. In this example, the time-series data 110 can include audio data representing the sound 106. In other embodiments, one or more cameras, one or more additional microphones, one or more sensors, or other devices that generate time-series data 110 can be coupled to the input interface(s) 108 to generate the time-series data 110 or a portion thereof. To illustrate, a light detection and ranging (LiDAR) system can be coupled to the input interface(s) 108, and the time-series data 110 can represent a sequence of point clouds based on LiDAR returns. In still other examples, other active sensors or sensor systems (where “active” indicates that such sensors or systems generate information based on signal returns) or other passive sensors or systems (where “passive” indicates that such sensors or systems are not reliant on signal returns) can be used to generate a sequence of sensor data corresponding to the time-series data 110.

In some embodiments, the device 102 includes a modem 170, in which case the time-series data 110 may be received via the modem 170. For example, one or more devices 160 can transmit the time-series data 110 to the device 102 via one or more modulated signals, and the modem 170 can demodulate the signals to generate the time-series data 110 provided to the processor(s) 190.

In some embodiments, the time-series data 110 can be stored in the memory 192 after receipt via the input interface(s) 108 and/or the modem 170. In such embodiments, one or more segments 196 of the time-series data 110 can be retrieved from the memory 192 for processing by the processing controller 140, by one or more of the downstream processing components 142 (e.g., responsive to the processing control signals 122), or both.

In the example illustrated in FIG. 1, the processing controller 140 includes a pre-processor 112, a feature extractor 116, and a classifier 120. The pre-processor 112 is configured to prepare segment data 114 as input for the feature extractor 116, the classifier 120, or both. As an example, for some types of time-series data 110, the pre-processor 112 may be configured to segment the time-series data 110 (e.g., using time-windowed sampling or framing), and each segment or a set of segments can be provided as a portion of the segment data 114. As another example, the pre-processor 112 can perform operations to modify the time-series data 110 (before or after segmentation). Examples of such modifications can include, without limitation, domain transforms (such as transforming time-domain data into frequency-domain data), resampling, normalization, filtering, signal enhancement, etc. In some embodiments, the pre-processor 112 generates at least a portion of the segment data 114 based on results of analysis of a segment of the time-series data 110. To illustrate, the pre-processor 112 can perform one or more statistical analyses of one or more segments of the time-series data 110 and provide statistics associated with the segment(s) as a portion of the segment data 114. In some embodiments, the pre-processor 112 also performs operations to generate input for the classifier 120. For example, the pre-processor 112 can perform mode detection operations to determine a mode indicator associated with one or more segments of the time-series data 110 and the mode indication can be provided as one input among a set of one or more inputs 118 to the classifier 120. As another example, the pre-processor 112 can determine features of the segment (e.g., using algorithmic rather than trained feature extraction processes). To illustrate, the pre-processor 112 can determine an open loop pitch, normalized correlation, a spectral envelope, a tonal stability, a signal non-stationarity, a linear prediction residual error, a spectral difference, a spectral stationarity, or a combination thereof, for the segment.

The feature extractor 116 and the classifier 120 each include one or more machine-learning models. Examples of machine-learning models include, without limitation, perceptrons, neural networks, support vector machines, regression models, decision trees, Bayesian models, Boltzmann machines, adaptive neuro-fuzzy inference systems, as well as combinations, ensembles and variants of these and other types of models. Variants of neural networks include, for example and without limitation, prototypical networks, autoencoders, transformers, self-attention networks, convolutional neural networks, deep neural networks, deep belief networks, etc. Variants of decision trees include, for example and without limitation, random forests, boosted decision trees, etc.

In some embodiments, the feature extractor 116 includes or corresponds to an autoencoder. In such embodiments, the autoencoder includes an inference network portion, a bottleneck layer, and a generation network portion. In some contexts, the inference network portion of the autoencoder is referred to as an encoder network, and the generation network portion of the autoencoder is referred to as a decoder network; however, inference network portion and generation network portion are used herein to avoid possible confusion with other optional aspects of the downstream processing components 142 described below.

The inference network portion of the autoencoder is configured to receive an input data sample (e.g., segment data 114 representing a segment of the time-series data 110) and to reduce the dimensionality of the input data sample to a dimensionality of the bottleneck layer. In some embodiments, the autoencoder is a variational autoencoder, in which case the inference network portion maps the dimensionally reduced representation of the input data sample to a probability distribution. The reduced dimensionality representation of the input data sample in the bottleneck layer is also referred to herein as a “latent-space representation”. When the input to the autoencoder includes segment data 114 for a segment of the time-series data 110, the latent-space representation at the bottleneck layer corresponds to or includes a latent-space representation of a segment of the time-series data 110.

At least during training of the autoencoder, the generation network portion is configured to generate output data that attempts to reconstruct the input data sample. For example, the generation network portion can receive the latent-space representation for a particular segment (or a sampled latent-space representation from a probability distribution in the case of a variational autoencoder) and perform dimensional expansion operations to generate output data having dimensionality corresponding to dimensionality of the input to the inference network portion. Thus, the latent-space representations are trained to control the properties of the output of the generative network portion (e.g., properties of synthesized speech or other target audio), and the latent-space representations for non-target audio (e.g., non-speech sounds) exhibit differences that can be used to classify the segments of audio data. For example, due to training of the feature extractor 116 to reconstruct data of a target data type, latent-space representations of the target data type tend to be separated, in latent space, from latent-space representations of the non-target data types. This latent-space separation of the target and non-target data types can be detected by the classifier (e.g., in the latent-space representations, or based on reconstruction error metrics associated with output of the generation network portion) to assign classifications to segments. For example, if the input data sample includes a particular segment of the time-series data 110, the output of the generation network portion includes data representing a synthesized reconstruction of the particular segment of the time-series data 110. In some embodiments, the output of the generation network portion is not used at runtime (e.g., after the feature extractor has been trained and is processing the time-series data 110). For example, operations of the generation network portion may be omitted (e.g., not performed by the processor(s) 190), or the output of the generation network portion may be discarded.

In some embodiments, output of the generation network portion (e.g., synthesized segment data) is used to determine at least a portion of the input 118 to the classifier 120. For example, the synthesized segment data can be compared to the segment data 114 to calculate an error metric, and the value of the error metric can be provided as part of the input 118. Since the dimensional reduction performed by the inference network portion is a lossy operation, the output of the generation network portion will generally differ from the input data sample, and the error metric quantifies differences between the output and the input. For example, the error metric can treat the input and the output as vectors representing locations in a feature space, and a value of the error metric can be calculated based on a distance between the vectors. As another example, the error metric can be calculated based on a comparison of a probability distribution associated with the input (e.g., the segment data 114) and a probability distribution associated with the output (e.g., the synthesized segment data). To illustrate, the error metric can be calculated using an Itakura-Saito distance based on the input and the output. Other examples of error metrics that can be used include, without limitation, a scale-invariant signal-to-distortion ratio or a log Spectral Distortion value.

In some embodiments, an autoencoder of the feature extractor includes one or more recurrent layers, one or more dilated convolution layers, and/or one or more other temporally dynamic layers. For example, the autoencoder can include one or more long short-term memory (LSTM) or gated recurrent unit (GRU) layers. Such temporally dynamic structures enable the analysis of a segment of the time-series data 110 to account for the segment's context within the time series.

In some embodiments, the classifier 120 includes or corresponds to a neural network, a decision tree, a support vector machine, or another machine-learning model or ensemble of machine-learning models configured to generate a classification output (e.g., an output indicating whether the input(s) 118 are associated with a target data type). As an example, the classifier 120 can include a neural network with an input layer configured to receive the input(s) 118, one or more hidden layers, and an output layer configured to generate an output that indicates a determination of whether the input(s) 118 are associated with the target data type or a probability that the input(s) 118 are associated with the target data type. In some embodiments, the classifier 120 is a one-class classifier or a binary classifier.

The processing controller 140 is configured to generate a processing control signal 122 for a particular segment of the time-series data 110 based on the output of the classifier 120. For example, if the classifier 120 indicates that the particular segment is assigned to a target data type, the processing controller 140 generates a first type of processing control signal 122, and if the classifier 120 indicates that the particular segment is not assigned to the target data type, the processing controller 140 generates a second type of processing control signal 122. As one non-limiting example, the time-series data 110 can represent audio content, and the target data type can be audio data representing speech. In this example, the classifier 120 generates an output indicating whether a particular segment of the time-series data 110 includes speech, and the processing controller 140 generates a processing control signal 122 based on whether the segment includes speech.

The processing control signal 122 associated with a segment is provided to one or more of the downstream processing components 142 to control which, if any, of a set of operations 130 available to the downstream processing components 142 are performed on the segment.

The specific operations 130 available to be performed by the downstream processing components 142 depend on the nature of the time-series data 110 and what the time-series data 110 is to be used for. Examples of operations 130 that can be performed by the downstream processing components 142 include, without limitation, encoding (e.g., for transmission), compression (e.g., for storage or transmission), rendering (e.g., for output), data integration (e.g., combining segments of the time-series data 110 with other data), etc.

In some embodiments, certain of the operations 130 are better suited for processing segments that include the target data type than are others of the operations 130. For example, first operations 130A may be optimized for processing segments of the target data type, second operations 130B may be optimized for processing segments that do not include the target data type, and Nth operations 130N may include general-purpose operations that are not optimized for any particular data type. As another example, the first operations 130A may be optimized for processing segments of the target data type, the second operations 130B may include general-purpose operations that are not optimized for any particular data type, and the Nth operations can be omitted.

As one specific, non-limiting example, when the time-series data 110 includes audio data representing sound, the first operations 130A can include a first audio encoder and the second operations 130B can include a second audio encoder. In this example, the first audio encoder can include a speech encoder that is specifically configured to encode audio data representing speech, and the second audio encoder can include a general-purpose audio encoder. In this example, the speech encoder may be able to encode speech audio frames in a manner that enables higher-fidelity reproduction of the speech frames, such as by de-emphasizing portions of an audio frame that are in frequency bands outside normal human speech, by emphasizing portions of an audio frame that are characteristic of normal human speech, or both. However, the speech encoder may be less efficient than the general-purpose audio encoder in terms of processing time, compression of the audio data, power utilization, or other factors. In this example, there may be advantages to using the first operations 130A (the speech encoder in this example) only for segments of the time-series data 110 that represent speech. Thus, the processing control signals 122 can indicate to the downstream processing components 142 which segment(s) of the time-series data 110 are to be processed using the first operations 130A based on which segment(s) include speech. While the target data type is audio data representing speech in the example above, in other examples, other types of target data are used. To illustrate, when the time-series data 110 include video data, the target data type may include video frames that represent motion, video frames that include faces, video frames that are blurry, video frames that have low lighting, etc.

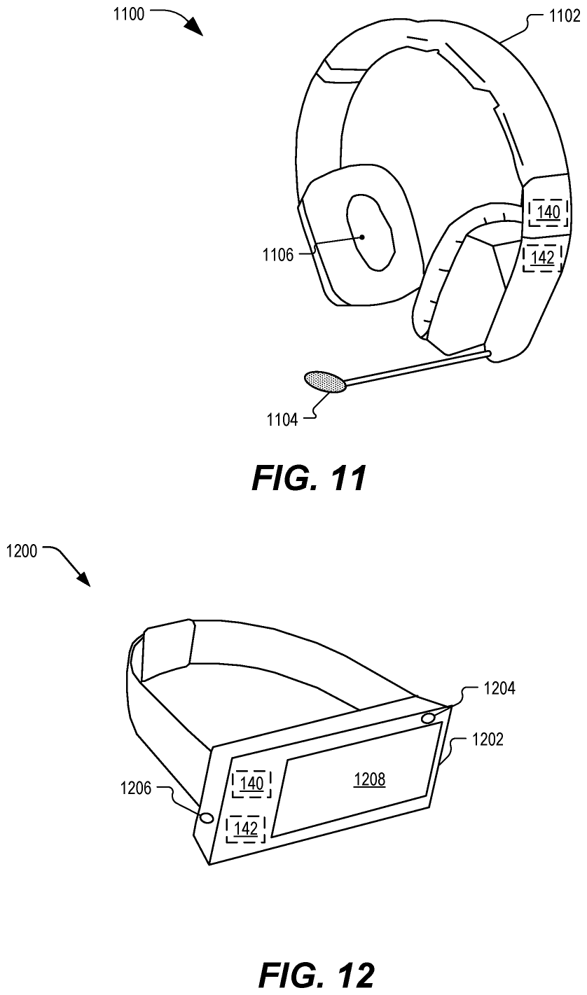

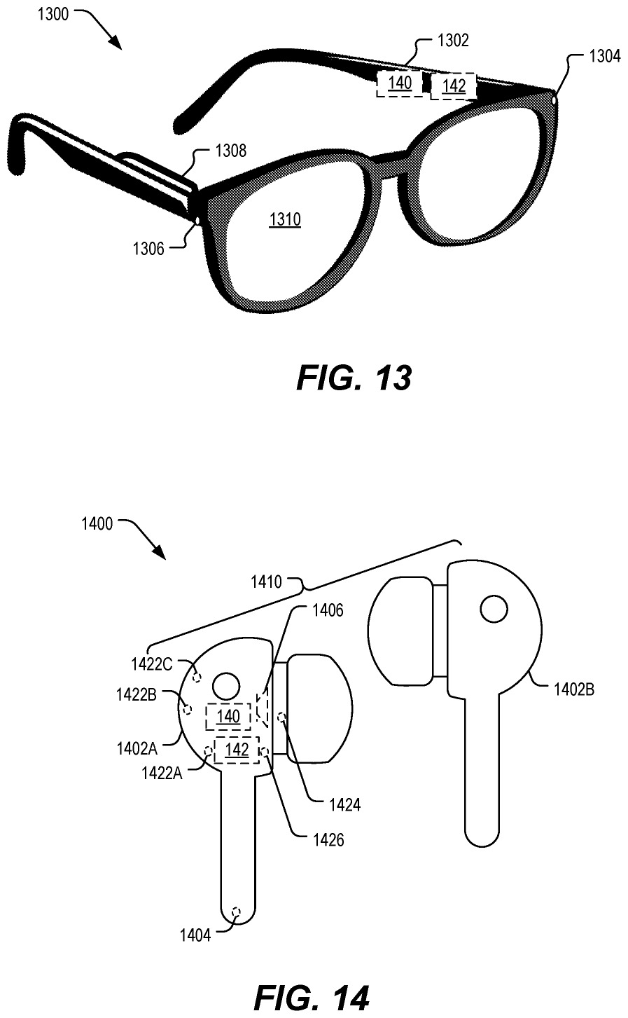

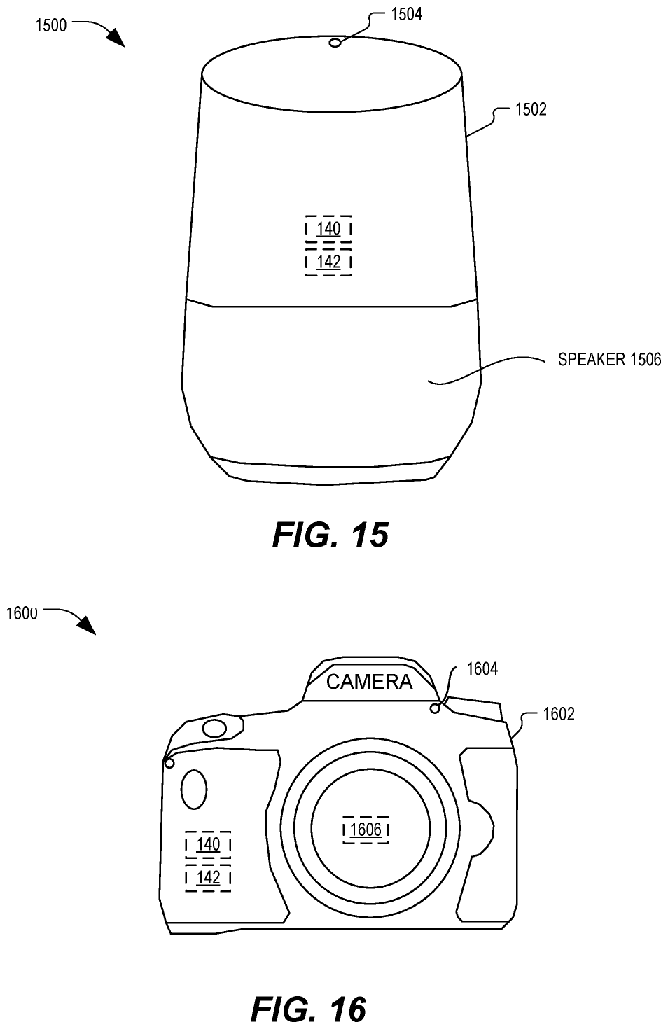

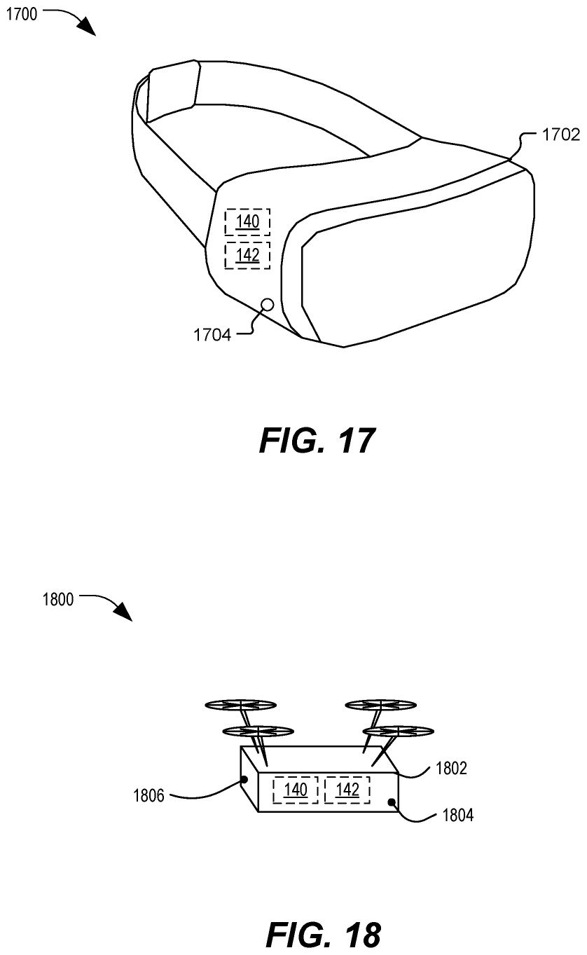

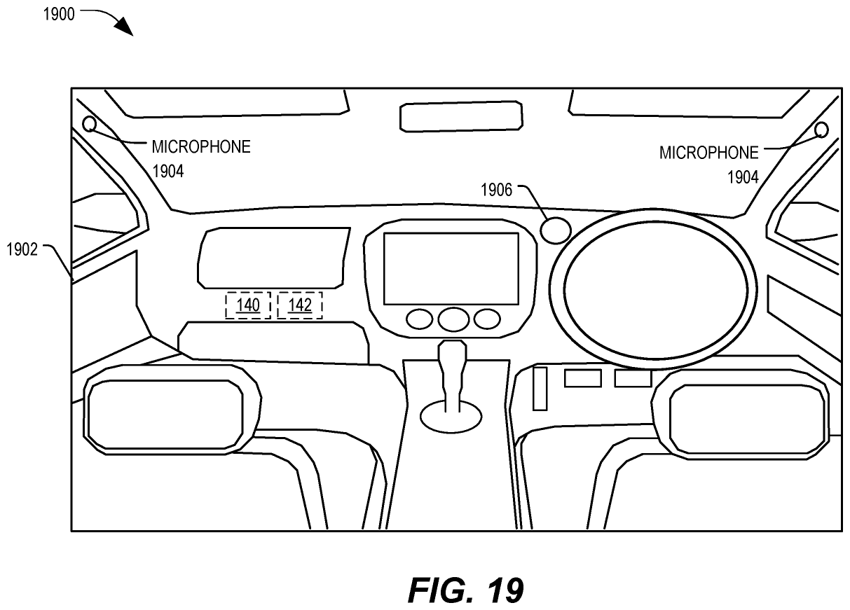

The device 102 can include, correspond to, or be included within one of various types of devices. To illustrate, in various embodiments, the processor(s) 190 are integrated in at least one of a mobile phone or a tablet computer device as described with reference to FIG. 10, a headset device as described further with reference to FIG. 11, a wearable electronic device as described with reference to FIG. 12, extended reality glasses as described with reference to FIG. 13, earbuds as described with reference to FIG. 14, a voice-controlled speaker system as described with reference to FIG. 15, a camera device as described with reference to FIG. 16, or an extended reality headset as described with reference to FIG. 17. In another illustrative example, the processor(s) 190 are integrated into a vehicle such as described further with reference to FIG. 18 and FIG. 19.

The system 100 is thus able to selectively route particular segments of the time-series data 110 to appropriate downstream processing components 142 based on content represented by segments (e.g., whether the segments represent data of a target data type) without advance information about the content of the segments. An advantage of such selective routing and processing is that downstream processing operations that may be less efficient but preferred for other reasons (such as speed or fidelity) can be performed for certain segments while other downstream processing operations that may be more efficient but less preferred for other reasons (such as speed or fidelity) can be performed for other segments of the time-series data. Additionally, or alternatively, downstream processing operations that are particular well suited to the target data type for other reasons than efficiency, speed, or fidelity can be used for segments that include the target data type, and other downstream processing operations (which may have other advantages) can be used for segments that do not include the target data type.

An additional benefit of particular aspects disclosed herein is that using an autoencoder as the feature extractor 116 and a one-class or binary classifier as the classifier 120 simplifies training when the time-series data 110 can include a large number of different types of data only one of which corresponds to the target data type. For example, an autoencoder can be trained using only data of the target data type. In contrast, many other types of machine-learning models need to be trained using data that is more representative of the data that is to be processed after training (e.g., data including both the target data type and one or more non-target data types). Limiting the training data needed to train the feature extractor reduces the cost (e.g., monetary cost and/or computing resource costs) of training the feature extractor.

Likewise, a one-class or binary classifier can be trained for use as the classifier 120 using a fairly limited data set. To illustrate, in some cases, training data to train a one-class classifier can include only examples of the target data type. In such cases, a limited data set that includes only examples of the target data type can be used to train both the feature extractor and the classifier 120, resulting in cost savings as described above. Generally, training of a binary classifier entails use of training data that includes both examples of data of the target data type and data of non-target data types; however, when there are many types of non-target data, the various non-target data types do not need to all be represented and/or can be imbalanced. As a result, the training data is subject to significantly fewer constraints than would be applied to training data used to train a multiclass classifier trained to distinguish among the various non-target data types.

Although FIG. 1A illustrates the microphone 104 coupled to the device 102, in other embodiments the microphone 104 may be integrated in the device 102. In still other embodiments, other sensors instead of or in addition to the microphone 104 can be coupled to or included within the device 102 to generate the time-series data 110. Further, although FIG. 1A illustrates the time-series data 110 being received by the processor(s) 190 from the input interface(s) 108, in other embodiments, the time-series data 110 can be received via a transmission from another device (e.g., one of the device(s) 160) and provided to the processor(s) 190 from the modem 170. In the same or different embodiments, time-series data 110 received via the input interface(s) 108, the modem 170, or both, can be saved to the memory 192 (e.g., as segment(s) 196) and the processor(s) 190 can obtain the segment(s) 196 from the memory 192 for processing.

In a particular embodiment, the processor(s) 190 are configured to execute instructions 194 from the memory 192 to perform one or more of the operations described above with reference to the processing controller 140 or the downstream processing components 142. For example, execution of the instructions 194 may cause the processor(s) 190 to generate, using the feature extractor 116, a latent-space representation of a segment of the time-series data 110; to provide input(s) 118 to the classifier 120, where the input(s) 118 include at least one input based on the latent-space representation; and to generate, based on output of the classifier 120, a processing control signal 122 for the segment. As another example, execution of the instructions 194 may cause the processor(s) to selectively, based on the processing control signal 122, perform the first operations 130A using the segment, perform the second operations 130B using the segment, or perform the Nth operations 130N using the segment. To illustrate, based on the processing control signal 122, the downstream processing components 142 may selectively perform first encoding operations (e.g., the first operations 130A) to encode the segment or perform second encoding operations (e.g., the second operations 130B) to encode the segment. In this illustrative example, the first encoding operations may provide more efficient encoding of a target signal class (e.g., a signal representing the target data type) than do the second encoding operations. Additionally, or alternatively, the first encoding operations may provide higher quality encoding of the target signal class than do the second encoding operations.

In some embodiments, the downstream processing components 142 include different components associated with different operations 130. In such embodiments, the processing control signals 122 can control activation and/or deactivation of various ones of the downstream processing components 142. For example, the first operations 130A may be performed by a first subset of the downstream processing components 142 and the second operations 130B may be performed by a second subset of the downstream processing components 142. In this example, when the processing control signal 122 associated with a particular segment of the time-series data 110 indicates that the first operations 130A are to be performed, the first subset of the downstream processing components 142 may be activated (e.g., powered on), the second subset of the downstream processing components 142 may be deactivated (e.g., powered down), or both.

FIG. 1B is a diagram of illustrative aspects of the system of FIG. 1A in accordance with some examples of the present disclosure. In particular, FIG. 1B illustrates the processing controller 140 and the downstream processing components 142 in an embodiment where the time-series data 110 includes audio data 158 and the target signal class corresponds to audio data representing speech. Thus, in the example illustrated in FIG. 1B, the processing control signals 122 select between a speech coder 144 when a segment of the audio data 158 is classified as representing speech or one or more non-speech coders 148 when a segment of the audio data 158 is not classified as representing speech.

For example, in FIG. 1B, when a segment of the audio data 158 is received, the processing controller 140 performs the operations as described with reference to FIG. 1A to assign a segment classification for the segment. In this example, the segment classification indicates whether the segment represents speech. If the segment classification indicates that the segment represents speech, the processing controller 140 generates processing control signals 122 selecting the speech coder 144. The segment of the audio data 158 is provided to the speech coder 144, which in this example performs linear prediction (LP)-based coding operations 146 to generate an output bitstream.

If the segment classification indicates that the segment does not represent speech (e.g., represents non-speech), the processing controller 140 generates processing control signals 122 selecting the non-speech coder(s) 148. The segment of the audio data 158 is provided to the non-speech coder(s) 148, and the non-speech coder(s) 148 perform appropriate coding operations for the segment. In the example illustrated in FIG. 1B, the non-speech coder(s) 148 are configured to perform frequency domain coding operations (such as, Modified Discrete Cosine Transform (MDCT) coding operations, Transform Coded Excitation (TCX) coding operations, etc.), inactive signal coding operations (such as, Comfort Noise Generation (CNG) operations). In some embodiments, the downstream processing components 142 of FIG. 1B correspond to coding modes of an Enhanced Voice Service (EVS) codec, in which case the downstream processing components 142 can include additional controls and/or switching to select among various non-speech coder(s) 148 based on factors such as signal-to-noise ratio or noise level of the audio data 158.

Output of the speech coder 144 and the non-speech coder(s) 148 can be combined at a multiplexer (MUX) 154 to generate a bitstream 156 representing the audio data 158.

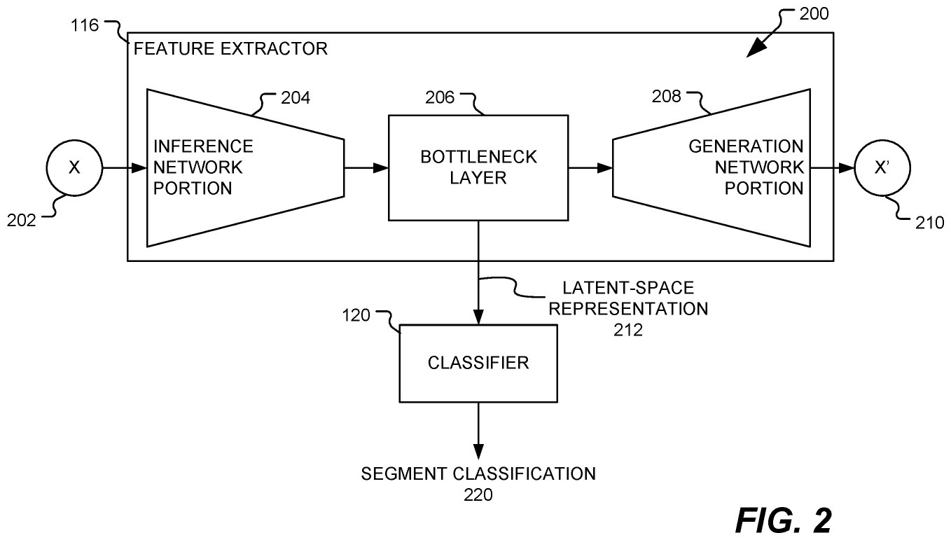

FIG. 2 is a diagram of illustrative aspects of the system of FIG. 1A in accordance with some examples of the present disclosure. In particular, FIG. 2 illustrates one example of the feature extractor 116 and the classifier 120 of the processing controller 140 of FIG. 1.

In the example illustrated in FIG. 2, the feature extractor 116 includes an autoencoder 200. The autoencoder 200 includes an inference network portion 204, a bottleneck layer 206, and a generation network portion 208. The inference network portion 204 is configured to receive an input data sample 202(X), such as segment data representing a segment of the time-series data 110 of FIG. 1, and to reduce the dimensionality of the input data sample 202 to a dimensionality of the bottleneck layer 206 to form a latent-space representation 212 of the input data sample 202.

In the example illustrated in FIG. 2, the latent-space representation 212 is provided as input to the classifier 120. The classifier 120 is configured to generate output indicating a segment classification 220 of the input data sample 202 based on the latent-space representation 212 of the input data sample 202. For example, the segment classification 220 may indicate whether the input data sample 202 includes data of a target data type. To illustrate, the classifier 120 can include a one-class classifier or a binary classifier, and the segment classification 220 can include a binary output that has a first value (e.g., a “1”) if the classifier 120 determines that the input data sample 202 includes a target data type and has a second value (e.g., a “0”) if the classifier 120 determines that the input data sample 202 does not include the target data type.

The processing controller 140 of FIG. 1A may output the segment classification 220 as a processing control signal 122 for a segment of the time-series data 110 that corresponds to the input data sample 202. Alternatively, the processing controller 140 of FIG. 1A can generate the processing control signal 122 for a segment of the time-series data 110 that corresponds to the input data sample 202 based on the segment classification 220. To illustrate, the processing controller 140 can include mapping data that maps particular processing control signals 122 to corresponding segment classifications 220.

The generation network portion 208 is configured to receive the latent-space representation 212 from the bottleneck layer 206 and to generate a synthesized reconstruction 210 (X′) of the input data sample 202(X). In some embodiments, the synthesized reconstruction 210 of the input data sample 202 generated by the generation network portion 208 is not used at runtime (e.g., after the feature extractor 116 has been trained and is processing the time-series data 110 of FIG. 1). In such embodiments, the generation network portion 208 can be omitted from the feature extractor 116 during use. For example, instructions and model parameters associated with the generation network portion 208 may not be loaded to the processor(s) 190 during use. In other embodiments, the generation network portion 208 is present in the feature extractor 116 during use, but output generated by the generation network portion 208 (e.g., the synthesized reconstruction 210 of the input data sample 202) is discarded, ignored, or used for purposes other than generating input to the classifier 120. Omitting or not executing the generation network portion 208 at runtime provides the benefit of conserving computing resources (e.g., processor time, memory I/O, power, etc.).

In some embodiments, the inference network portion 204, the generation network portion 208, or both, include one or more recurrent layers, one or more dilated convolution layers, and/or one or more other temporally dynamic layers, such as LSTM layer(s), GRU layer(s), etc. The presence of recurrent and/or temporally dynamic layers enables the latent-space representation 212, the synthesized reconstruction 210 of the input data sample 202, or both, to account for other data samples of a time series that form the context of the input data sample 202.

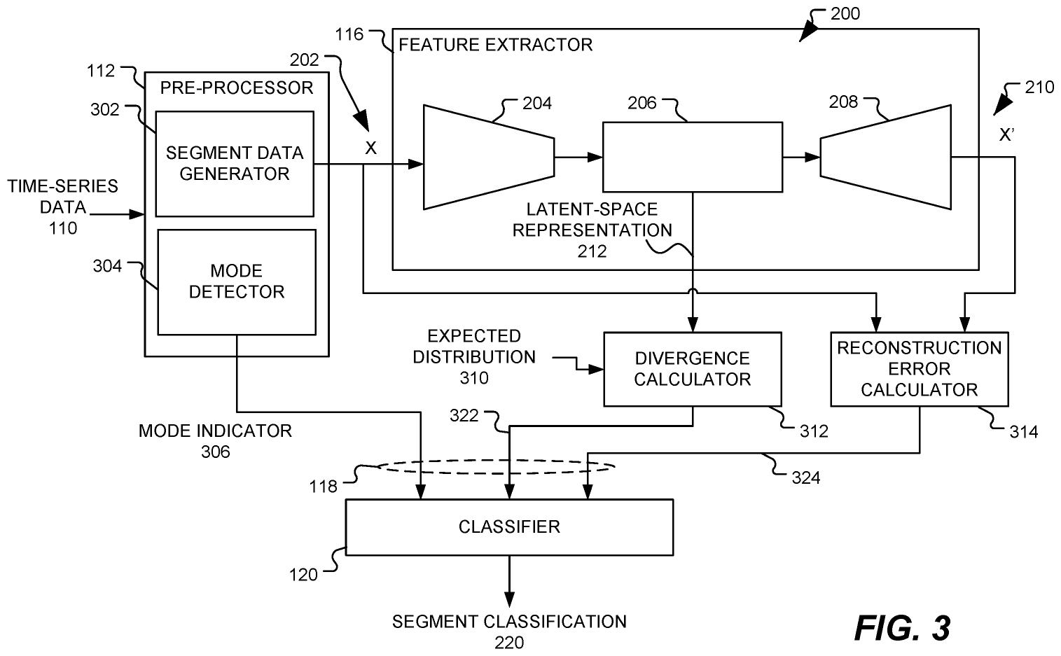

FIG. 3 is a diagram of illustrative aspects of the system of FIG. 1A in accordance with some examples of the present disclosure. In particular, FIG. 3 illustrates examples of the pre-processor 112, the feature extractor 116, and the classifier 120 of the processing controller 140 of FIG. 1.

In the example of FIG. 3, the feature extractor 116 includes the same features and functions as described with reference to FIG. 2. For example, the feature extractor 116 of FIG. 3 includes the autoencoder 200 of FIG. 2, which includes the inference network portion 204, the bottleneck layer 206, and the generation network portion 208. The inference network portion 204 is configured to receive an input data sample 202 (X) (such as segment data representing a segment of the time-series data 110 of FIG. 1) and to reduce the dimensionality of the input data sample 202 to the dimensionality of the bottleneck layer 206 to form the latent-space representation 212 of the input data sample 202. The generation network portion 208 is configured to receive the latent-space representation 212 from the bottleneck layer 206 and generate the synthesized reconstruction 210 (X′) of the input data sample 202(X).

Further, in the example of FIG. 3, the classifier 120 is configured to receive one or more inputs 118 and generate output indicating a segment classification 220 of the input data sample 202 based on the one or more inputs 118. As described further below, the one or more inputs 118 include at least one input that is based on the latent-space representation 212 of the input data sample 202.

In FIG. 3, the pre-processor 112 includes a segment data generator 302. The segment data generator 302 is configured to generate the input data samples (e.g., the input data sample 202) based on the time-series data 110. Specific operations performed by the segment data generator 302 depend on the nature (e.g., content and format) of the time-series data 110. For example, if the time-series data 110 includes one or more analog signals, the segment data generator 302 can perform framing operations to generate time-windowed samples of the analog signals, where each time-windowed sample or a set of time-windowed samples corresponds to a segment of the time-series data 110. Framing operations may also be performed in some instances in which the time-series data includes a bit stream or one or more modulated signals. As other examples, depending on the format and content of the time-series data 110, the segment data generator 302 can perform filtering operations, spectral analysis operations, domain transform operations, data aggregation operations, statistical analysis operations, etc. to generate a segment of the time-series data 110.

Optionally, the pre-processor 112 can include a mode detector 304. In embodiments in which the pre-processor 112 includes the mode detector 304, the mode detector 304 is configured to analyze the time-series data 110 to determine a mode indicator 306 associated with one or more segments of the time-series data 110. In such embodiments, the input(s) 118 to the classifier 120 can include the mode indicator 306.

The mode detector 304 is configured to perform relatively light-weight and/or efficient analysis of the segments of the time-series data (as compared to operations performed by the feature extractor 116 and the classifier 120) to generate the mode indicator 306. For example, the mode detector 304 can use statistical techniques, pattern matching, etc. As one example, when the time-series data 110 includes audio data, the mode detector 304 can include a speech mode detector configured to distinguish voiced speech from unvoiced speech. In this example, the mode indicator 306 for a particular segment of the time-series data 110 is generated based on an assumption that the particular segment includes speech (whether or not the segment actually does include speech). Thus, in this example, if the segment includes voiced speech, the mode indicator 306 indicates that the segment includes voiced speech, and if the segment does not include voiced speech (e.g., includes unvoiced speech, silence, music, or any other sound), the mode indicator 306 has some indeterminate value, such as a random value that may indicate voiced speech or unvoiced speech. Accordingly, in this example, the mode indicator 306 is not reliable to indicate the segment classification 220, but does provide some data that can be used by the classifier 120 to assign the segment classification 220. As another example, the mode indicator can include an Enhanced Variable Rate Codec (EVRC) mode decision based on the segment.

In other examples, the mode detector 304 is configured to distinguish other sounds, such as distinguishing speech from music or distinguishing wind noise from other sounds. In still other examples, the time-series data 110 includes information other than or in addition to sound, such as video data or sensor readings, and the mode detector 304 performs mode detection appropriate for such other data. To illustrate, when the time-series data 110 includes video data (e.g., a sequence of images), the mode indicator 306 for a particular image (e.g., a segment of the video data) can indicate whether the image includes a face.

In FIG. 3, the input(s) 118 to the classifier 120 include at least one input based on the latent-space representation 212. To illustrate, in FIG. 3, the input(s) 118 include a divergence value 322 and a reconstruction error value 324, each of which is based on the latent-space representation 212.

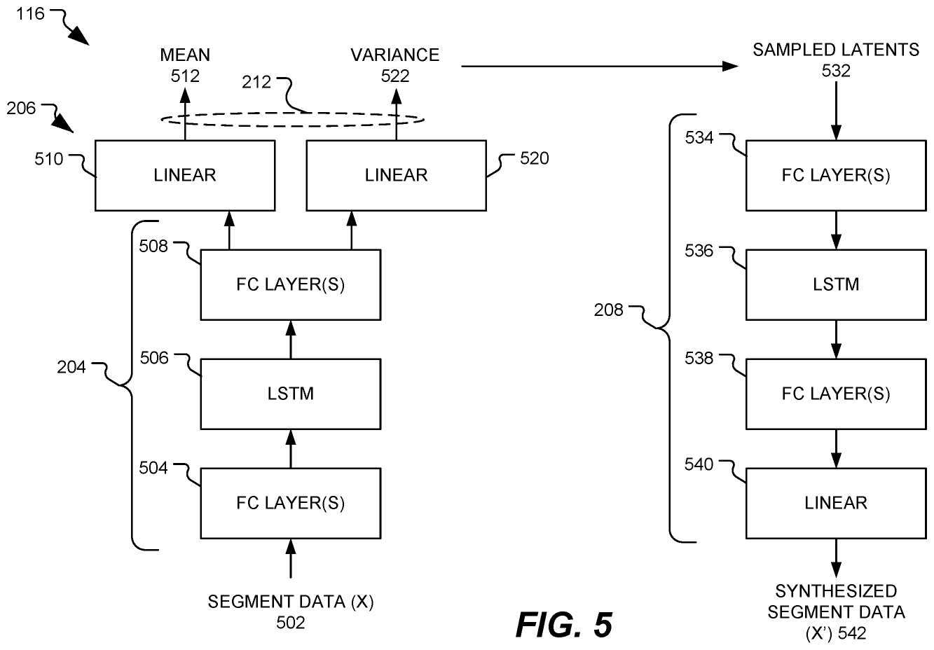

In a particular aspect, the processing controller 140 of FIG. 1A includes a divergence calculator 312 that is configured to determine the divergence value 322. The divergence value 322 is a type of error value that is indicative of divergence between a probability distribution of the latent-space representation 212 and an expected distribution 310. In embodiments in which the divergence value 322 is among the input(s) 118 to the classifier 120, the autoencoder 200 of the feature extractor 116 corresponds to a variational autoencoder (VAE). As described further with reference to FIG. 5, the latent-space representation 212 of a VAE includes data representing a probability distribution (e.g., includes a mean and a variance). In such embodiments, during training, the latent-space representation 212 of the VAE is normalized to an expected probability distribution (e.g., the expected distribution 310). A divergence value 322 during inference time (i.e., after the VAE is trained) indicates divergence between the probability distribution of the latent-space representation 212 and the expected distribution 310. The divergence value 322 can be calculated, for example and without limitation, as a Kullback-Leibler divergence or another f-divergence indicative of differences between two probability distributions.

In a particular aspect, the processing controller 140 of FIG. 1A includes a reconstruction error calculator 314 that is configured to determine the reconstruction error value 324. The reconstruction error value 324 is indicative of how closely a synthesized reconstruction 210 (based on the latent-space representation 212 of an input data sample 202) matches the input data sample 202. Examples of calculations that can be used to determine the reconstruction error value 324 include, without limitation, a cosine distance, an Itakura-Saito distance, a scale-invariant signal-to-distortion ratio, and a log Spectral Distortion value.

Although FIG. 3 illustrates three inputs 118 to the classifier 120, in other examples, the inputs 118 to the classifier 120 can include more than three or fewer than three inputs. As an example, the mode indicator 306 can be omitted from the inputs 118. Additionally, or alternatively, either the reconstruction error value 324 or the divergence value 322 can be omitted from the inputs 118. As another example, the pre-processor 112 can include more than one mode detector 304, in which case the inputs 118 can include more than one mode indicator 306. To illustrate, the pre-processor 112 can include a speech mode detector and a music mode detector, each of which generates a respective mode indicator 306 that is provided as input to the classifier 120.

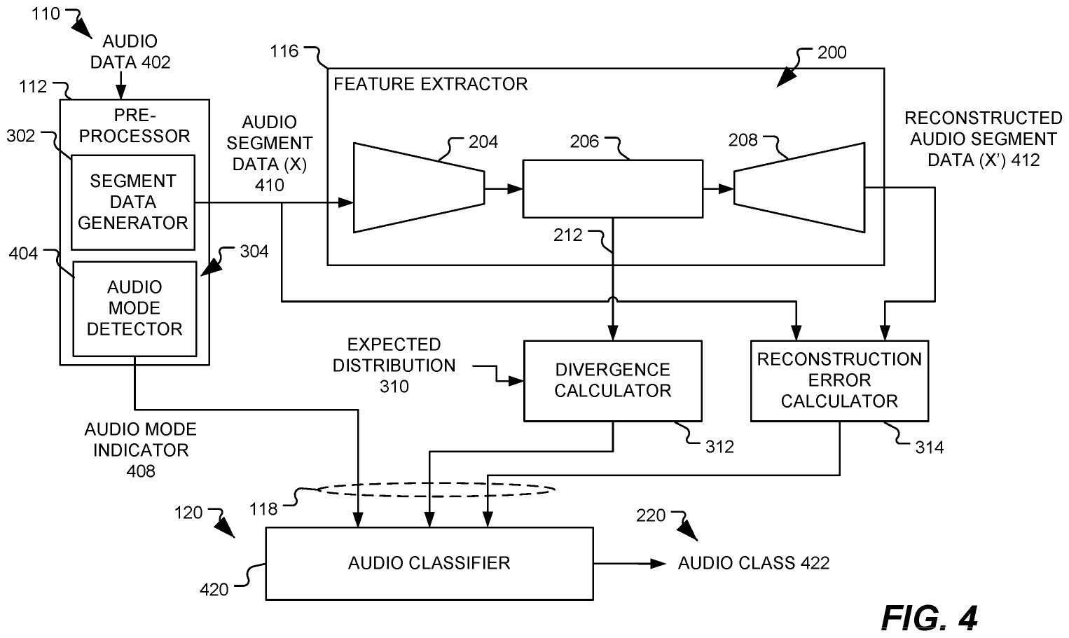

FIG. 4 is a diagram of illustrative aspects of the system of FIG. 1A in accordance with some examples of the present disclosure. In particular, FIG. 4 illustrates an example of FIG. 3 in which the time-series data 110 includes audio data 402.

The example illustrated in FIG. 4 includes the pre-processor 112, the feature extractor 116, and the classifier 120, each of which may be adapted to operate on the audio data 402 and/or audio segment data 410 based on the audio data 402. For example, the pre-processor 112 of FIG. 4 includes the segment data generator 302, which is configured to generate the audio segment data 410 based on the audio data 402. As another example, the feature extractor 116 includes the autoencoder 200, which is trained to accept audio segment data 410 as input, to generate a latent-space representation 212 of the audio segment data 410, and to generate reconstructed audio segment data 412 based on the latent-space representation 212.

Optionally, the pre-processor 112 of FIG. 4 can also include an audio mode detector 404, which is an example of the mode detector 304. The audio mode detector 404 is configured to generate an audio mode indicator 408, such as a speech mode indicator, a music mode indicator, etc.

In the example of FIG. 4, the classifier 120 includes or corresponds to an audio classifier 420. In this example, the audio classifier 420 is configured to receive one or more input(s) 118, such as one or more of the inputs described with reference to any of FIGS. 1A-3, and to generate a segment classification 220, such as an audio class 422. As one non-limiting example, the audio class 422 can indicate whether the audio segment data 410 includes data representing speech. In this example, when the audio segment data 410 includes data representing speech, the processing controller 140 of FIG. 1A can send a processing control signal 122 to the downstream processing components 142 to cause the downstream processing components 142 to perform speech processing operations (e.g., the first operations 130A). The downstream processing components 142 can, responsive to the processing control signal 122, obtain the portion of the audio data 402 associated with the processing control signal 122 (e.g., an audio segment corresponding to the audio segment data) and process the portion of the audio data 402 using the speech processing operations.

Alternatively, in the example above, if the audio segment data 410 does not include data representing speech (as indicated by the audio class 422), the processing controller 140 of FIG. 1A can send a processing control signal 122 to the downstream processing components 142 to cause the downstream processing components 142 to perform non-speech processing operations (e.g., the second operations 130B). The downstream processing components 142 can, responsive to the processing control signal 122, obtain the portion of the audio data 402 associated with the processing control signal 122 (e.g., an audio segment corresponding to the audio segment data) and process the portion of the audio data 402 using the non-speech processing operations.

FIG. 5 is a diagram of illustrative aspects of the system of FIG. 1A in accordance with some examples of the present disclosure. In particular, FIG. 5 illustrates one example of the feature extractor 116. In the example illustrated in FIG. 5, the feature extractor 116 includes a recurrent VAE. As explained above, in other examples, the feature extractor 116 includes a different type of machine-learning model. The embodiment depicted in FIG. 5 illustrates a low-complexity, non-autoregressive generative network portion 208 (e.g., so that the latent space contains most of the information) in which simple priors are applied to gain information that is useful during inference (e.g., by the classifier 120).

In FIG. 5, the feature extractor 116 includes the inference network portion 204, the bottleneck layer 206, and the generation network portion 208. The inference network portion 204 includes one or more fully connected (FC) layers 504 configured to receive segment data 502 as input. The FC layer(s) 504 are coupled to one or more LSTM layers, which are configured to dimensionally reduce the segment data 502, account for a context of the segment data 502 in a time series, or both. The LSTM layer(s) 506 are coupled to one or more FC layers 508 which are configured to perform dimensional reduction (or further dimensional reduction) of the segment data 502.

The FC layer(s) 508 are coupled to linear layers 510 and 520, which correspond to the bottleneck layer 206. The linear layer 510 is configured to generate output representing a mean 512 of the latent-space representation 212, and the linear layer 520 is configured to generate output representing a variance 522 of the latent-space representation 212.

The generation network portion 208 is configured to sample a probability distribution of the latent-space representation 212 to determine sampled latents 532 as input. In the example illustrated in FIG. 5, the generation network portion 208 includes hidden layers arranged as a mirror image of hidden layers of the inference network portion 204. For example, the generation network portion 208 includes one or more FC layers 534 coupled to one or more LSTM layers 536, and one or more FC layers 538 coupled to the one or more LSTM layers 536. The generation network portion 208 also includes a linear layer 540 as an output layer coupled to the FC layer(s) 538. The linear layer 540 is configured to generate synthesized segment data 542 as output.

As explained above, in some embodiments, the output of the generation network portion 208 (e.g., the synthesized segment data 542 in FIG. 5) is not used by the classifier. In such embodiments, fidelity of the synthesized segment data 542 to the segment data 502 is not critical for proper runtime (e.g., post-training) operation of the processing controller 140. Accordingly, in some such embodiments, the hidden layers of the generation network portion 208 are not a mirror image of the hidden layers of the inference network portion 204. For example, the generation network portion 208 can include fewer hidden layers than the inference network portion 204. As another example, the generation network portion 208 can include different hidden layers than the inference network portion 204. To illustrate, the LSTM layer(s) 528 of the generation network portion 208 can be omitted. While such differences between the generation network portion 208 and the inference network portion 204 may increase reconstruction error, reducing the number of hidden layers and/or the complexity of the hidden layers of the generation network portion 208 conserves computing resources.

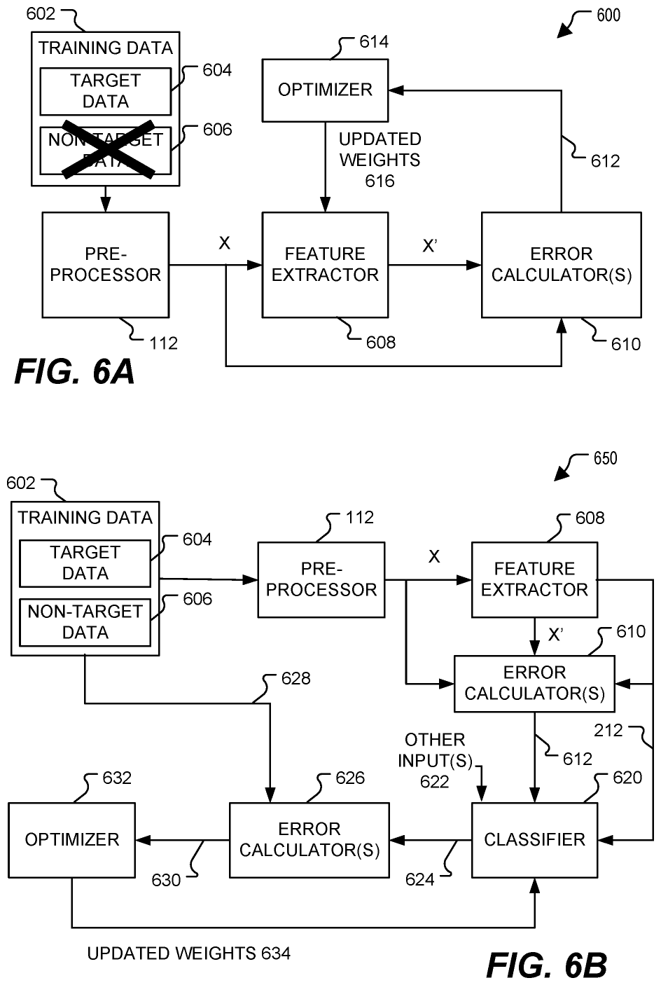

FIG. 6A illustrates aspects of training a feature extractor for use by the system of FIG. 1, and FIG. 6B illustrates aspects of training a classifier for use by the system of FIG. 1A in accordance with some examples of the present disclosure. In the example illustrated in FIGS. 6A and 6B, the feature extractor and classifier are trained separately.

Referring to FIG. 6A, a training system 600 to train a feature extractor 608 includes training data 602, the pre-processor 112, the feature extractor 608, one or more error calculators 610, and an optimizer 614. The pre-processor 112 is optional and is used when the pre-processor 112 will be used after training (e.g., in the inference phase). The feature extractor 608 can include an autoencoder, such as the autoencoder 200 of FIGS. 2-5. Initially, parameters (e.g., weights, biases, etc.) of the feature extractor 608 have not been adapted such that an output (X′) of the feature extractor 608 represents the input (X). The training process is iterative, and gradually updates the parameters to decrease mismatch between the input (X) and the output (X′), as explained further below.

In a particular aspect, the training data 602 used to train the feature extractor 608 includes target data 604 and can omit non-target data 606. For example, when the target data includes speech, the training data 602 can include audio data segments or files representing audio data streams, where each audio data segment includes speech, and no audio data segment is devoid of speech. The training data 602 generally includes a large number of data samples (e.g., segments) that are provided individually or in groups to the training system 600 to train the feature extractor.

During one iteration of the training system 600, a segment of the target data 604 or a group of segments of the target data 604 (e.g., a batch of sequential segments representing a time-series) are provided to the pre-processor 112. The pre-processor 112 generates input (X) to the feature extractor 608, where the input (X) corresponds to or includes segment data, such as segment data 114, representing a segment of the training data 602.

The feature extractor 608 processes the input (X) as described above with reference to the autoencoder 200 of FIGS. 2-5. For example, the feature extractor 608 passes data between multiple hidden layers to dimensionally reduce the input (X) to form a latent-space representation and processes the latent-space representation to generate an output (X′) based on the input (X).

The output (X′) and the input (X) are provided to the error calculator(s) 610 to generate one or more error metrics 612. The error metric(s) 612 are indicative of differences between the input (X) and the output (X′). For example, the error calculator(s) 610 can include the reconstruction error calculator 314 of FIG. 3. In some embodiments, the error calculator(s) 610 also, or alternatively, include the divergence calculator 312 of FIG. 3. The error metric(s) 612 are provided to an optimizer 614, which uses the error metric(s) 612 to generate updated weights 616 for the feature extractor 608. The updated weights 616 are generated with a goal of decreasing the error metric(s) 612, e.g., using a gradient descent backpropagation process or another machine-learning optimization process.

After the feature extractor 608 is updated based on the updated weights 616, one or more additional iterations can be performed by the training system 600 until a termination condition is satisfied. For example, the termination condition can be satisfied when a fixed (e.g., predetermined) number of iterations have been performed. As another example, the termination condition can be satisfied when the error metric(s) 612 meet a specified threshold or when a rate of change of the error metric(s) 612 (e.g., from one iteration to the next) meets a specified threshold.

When the termination condition is satisfied, training of the feature extractor 608 is complete. The feature extractor 608 can subsequently be validated (e.g., using validation data similar to the trained data 602) and/or used to train a classifier, as described below with reference to FIG. 6B.

Referring to FIG. 6B, a training system 650 to train a classifier 620 includes portions of the training system 600, such as the training data 602, the pre-processor 112, the feature extractor 608, and the error calculator(s) 610. The training system 650 also includes the classifier 620, one or more error calculators 626, and an optimizer 632. The portions of the training system 600 present in the training system 650 operate as described with reference to FIG. 6A, except that both the target data 604 and the non-target data 606 are used during training of the classifier 620, and the feature extractor 608 is already trained. Accordingly, parameters of the feature extractor 608 are not changed during training of the classifier 620 using the training system 650.

During one iteration of the training system 650, a segment of the training data 602 or a group of segments of the training data 602 (e.g., a batch of sequential segments representing a time-series) are provided to the pre-processor 112. The pre-processor 112 generates input (X) to the feature extractor 608, where the input (X) corresponds to or includes segment data, such as segment data 114, representing a segment of the training data 602. The training data 602 provided to the pre-processor 112 can include one or more data samples selected from among the target data 604, one or more data samples selected from among the non-target data 606, or both. As one example, batch training can be used where batches representing target data 604 are alternated with batches representing non-target data 606, though other batch training schemes can be used.

The feature extractor 608 processes the input (X) as described above to generate a latent-space representation 212 based on the input (X) and to generate an output (X′) based on the latent-space representation 212. In some embodiments, the output (X′) and the input (X) are provided to the error calculator(s) 610 to generate one or more error metrics 612. For example, the error calculator(s) 610 can include the reconstruction error calculator 314 of FIG. 3. In some embodiments, the latent-space representation 212 is provided to the error calculator(s) 610 to generate one or more error metrics 612. For example, the error calculator(s) 610 can include the divergence calculator 312 of FIG. 3.

At least one input based on the latent-space representation 212 is provided to the classifier 620. For example, the input(s) based on the latent-space representation 212 can include the latent-space representation 212, a divergence value from the error calculator(s) 610, a reconstruction error value from the error calculator(s) 610, or a combination thereof. In some embodiments, one or more other inputs 622 can also be provided to the classifier 620. For example, the other input(s) 622 can include one or more mode indicators, as described above.

Based on the inputs, the classifier 620 generates a classification output 624, such as the segment classification 220 of FIG. 2 or the audio class 422 of FIG. 4. The classification output 624 for a particular segment of the training data 602 and a label 628 associated with the particular segment are provided to the error calculator(s) 626. The error calculator(s) 626 generate an error metric 630 (typically for a batch or group of training data 602) indicating differences between the classification output 624 and the corresponding labels 628, and the optimizer 632 determines updated weights 634 for the classifier 620 based on the error metric 630.

After the classifier 620 is updated based on the updated weights 634, one or more additional iterations can be performed by the training system 650 until a termination condition is satisfied. For example, the termination condition can be satisfied when a fixed (e.g., predetermined) number of iterations have been performed. As another example, the termination condition can be satisfied when the error metric(s) 630 meets a specified threshold or when a rate of change of the error metric(s) 630 (e.g., from one iteration to the next) meets a specified threshold.

When the termination condition is satisfied, training of the classifier 620 is complete, and the feature extractor 608 and classifier 620 can be deployed for runtime use (e.g., in an inference phase) as part of the processing controller 140 of FIG. 1.

One benefit of training the feature extractor 608 and the classifier 620 in separate training operations, as described with reference to FIGS. 6A and 6B, is that the training data 602 does not need to include a well-balanced selection of target data 604 and non-target data 606. For example, the feature extractor 608 can be trained solely using target data 604. Training the classifier 620 does generally require use of some non-target data 606; however, when the classifier 620 is a one-class classifier, the target and non-target data 604, 606 can be imbalanced (that is, the set of target data 604 can be much larger than the set of non-target data 606). When the classifier 620 is a binary classifier, the target and non-target data 604, 606 may need to be more balanced than would be needed for training a one-class classifier; however, the non-target data 606 does not need to include samples of each possible or each expected non-target data type.

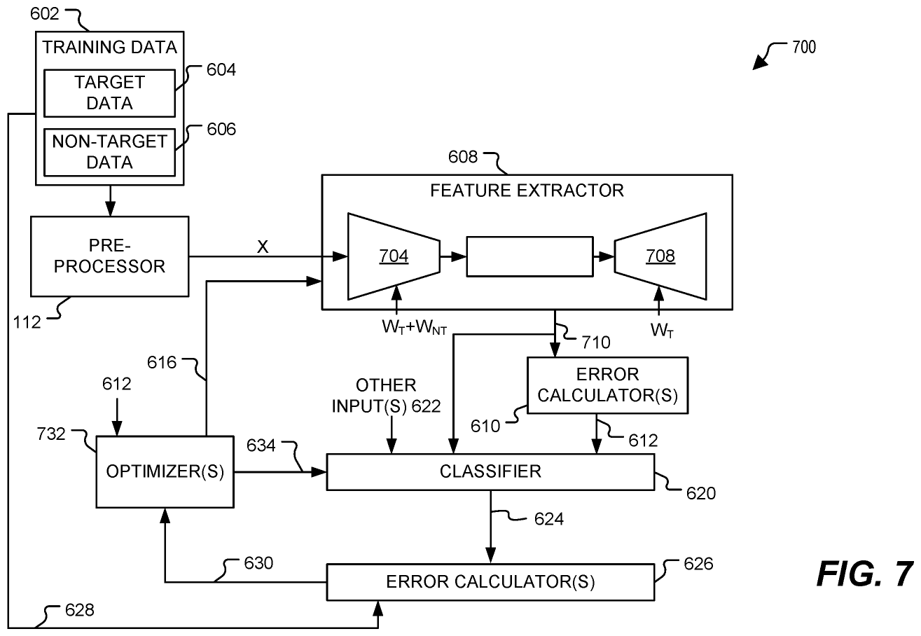

FIG. 7 illustrates aspects of training a feature extractor and a classifier for use by the system of FIG. 1A in accordance with some examples of the present disclosure. In contrast to the training scheme described with reference to FIGS. 6A and 6B, the feature extractor 608 and the classifier 620 are trained together by a training system 700 of FIG. 7. The training system 700 includes many of the same features as the training systems 600 and 650, and such features operate as described with reference to FIGS. 6A and 6B, except as noted below. For example, the training system 700 includes the training data 602 (which includes target data 604 and non-target data 606), the pre-processor 112, the feature extractor 608, the error calculator(s) 610, the classifier 620, and the error calculator(s) 626. The training system 700 also includes one or more optimizers 732, which may include the optimizer 614 of FIG. 6A, the optimizer 632 of FIG. 6B or an optimizer that combines aspects of both the optimizer 614 and the optimizer 632.

During each iteration of the training system 700, a group of segments of the training data 602 (e.g., a batch of sequential segments representing a time-series) are provided to the pre-processor 112. Generally, the batch of training data 602 used in each iteration includes only target data 604 or only non-target data 606.

For each segment of the batch, the pre-processor 112 generates input (X) to the feature extractor 608, where the input (X) corresponds to or includes segment data, such as segment data 114, representing a segment of the training data 602. The feature extractor 608 processes the input (X) as described above to form a latent-space representation and a synthesized segment (X′) based on the latent-space representation. The latent-space representation, the synthesized segment (X′), or both, are provided as output 710 from the feature extractor 608.

The output 710 of the feature extractor 608 is provided to the error calculator(s) 610, to the classifier 620, or both. For example, to train the classifier 120 of FIG. 2, the output 710 includes the latent-space representation from the feature extractor 608, and the output 710 is provided to the classifier 620. In this example, the error calculator(s) 610 can be omitted. As another example, to train the classifier 120 of FIG. 3, the output 710 includes the latent-space representation, the synthesized segment (X′), or both. In this example, the latent-space representation can be provided to a divergence calculator (e.g., the divergence calculator 312 of FIG. 3) along with information describing an expected distribution (e.g., the expected distribution 310) to determine a divergence metric (e.g., the divergence value 322). Additionally, or alternatively, the synthesized segment (X′) can be provided to a reconstruction error calculator (e.g., the reconstruction error calculator 314 of FIG. 3) along with the input (X) to determine a reconstruction error metric (e.g., the reconstruction error value 324). An error metric 612 from the error calculator(s) 610 can include the divergence metric, the reconstruction error metric, or both.

At least one input based on the latent-space representation from the feature extractor 608 is provided to the classifier 620. For example, the input(s) based on the latent-space representation can include the latent-space representation, a divergence value from the error calculator(s) 610, a reconstruction error value from the error calculator(s) 610, or a combination thereof. In some embodiments, the other input(s) 622 can also be provided to the classifier 620. For example, the other input(s) 622 can include one or more mode indicators, as described above.

Based on the input(s), the classifier 620 generates a classification output 624, such as the segment classification 220 of FIG. 2 or the audio class of FIG. 4. The classification output 624 for a particular segment of the training data 602 and a label 628 associated with the particular segment are provided to the error calculator(s) 626. The error calculator(s) 626 generate an error metric 630 (typically for a batch or group of training data 602) indicating differences between the classification output 624 and the corresponding labels 628.

The error metric 630 and possibly other data, such as the error metric 612, are provided to the optimizer(s) 732. The optimizer(s) 732 determines updated weights 616 for the feature extractor 608, updated weights 634 for the classifier 620, or both. In a particular aspect, when the training data 602 used in a particular iteration includes target data 604 (and omits non-target data 606), the updated weights 616 include weights based on target data (WT), which are applied to both an inference network portion 704 and a generation network portion 708 of the feature extractor 608. In contrast, when the training data 602 used in a particular iteration includes non-target data 606 (and omits target data 604), the updated weights 616 include weights based on non-target data (WNT), which are only applied to the inference network portion 704 of the feature extractor 608. In this manner, the generation network portion 708 is only updated based on the target data 604.

After the feature extractor 608 and the classifier 620 are updated, one or more additional iterations can be performed by the training system 700 until a termination condition is satisfied. For example, the termination condition can be satisfied when a fixed (e.g., predetermined) number of iterations have been performed. As another example, the termination condition can be satisfied when one or more of the error metric(s) 612 or 630 meet a specified threshold or when a rate of change of one or more of the error metric(s) 612 or 630 (e.g., from one iteration to the next) meets a specified threshold.

When the termination condition is satisfied, training of the feature extractor 608 and the classifier 620 is complete, and the feature extractor 608 and classifier 620 can be deployed for runtime use (e.g., in an inference phase) as part of the processing controller 140 of FIG. 1.

One benefit of training the feature extractor 608 and the classifier 620 together, as described with reference to FIG. 7, is that improved separation between latent-space representations for target data 604 and latent-space representations for non-target data 606 can be achieved, which can improve classification accuracy of the classifier 620. For example, when the feature extractor 608 and the classifier 620 are trained together, the inference network portion 704 of the feature extractor 608 is updated based on both target data 604 and non-target data 606, thus the inference network portion 704 becomes adept at (e.g., is trained to) generate latent-space representations for both target data 604 and non-target data 606. The generation network portion 708 is not trained to synthesize non-target data 606 accurately, because having a large reconstruction error for non-target data 606 facilitates identification of the non-target data 606 by the classifier 620.

The training operations described above with reference to FIGS. 6A-7 are merely illustrative. Variations to the above-described training operations and/or different training operations can be used to train machine-learning models for use as the feature extractor 116, the classifier 120, or both.

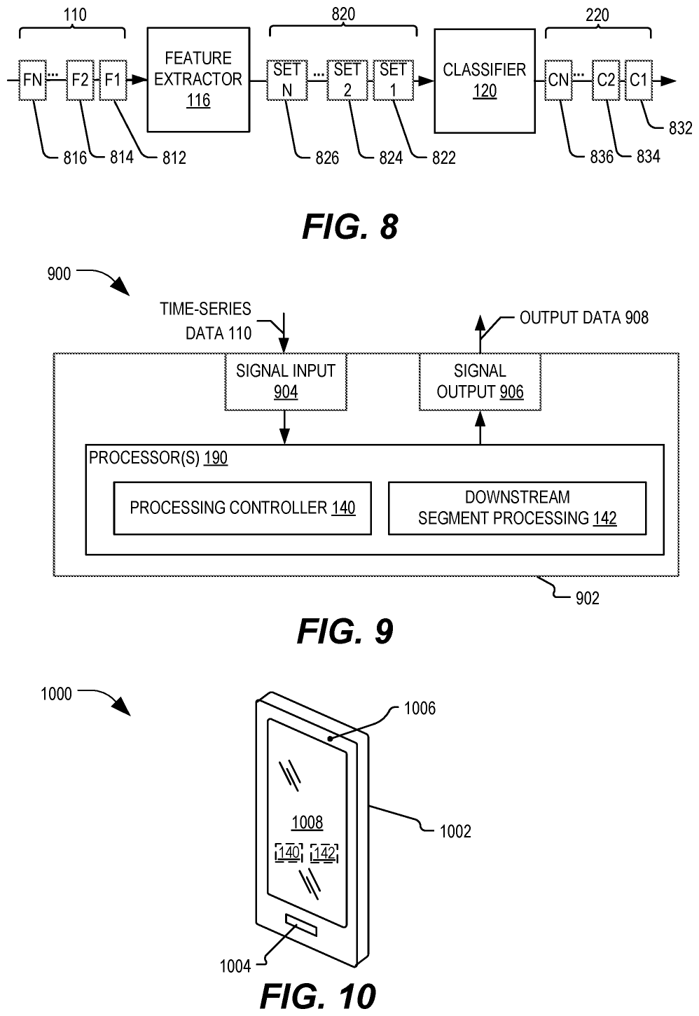

FIG. 8 is a diagram of an illustrative aspect of operation of components of the system of FIG. 1, in accordance with some examples of the present disclosure. In FIG. 8, the feature extractor 116 is configured to receive a sequence of data samples corresponding to the time-series data 110. For example, the time-series data 110 can include a sequence of successively captured frames of the audio data, illustrated as a first frame (F1) 812, a second frame (F2) 814, and one or more additional frames including an Nth frame (FN) 816 (where N is an integer greater than two). The feature extractor 116 is configured to output a sequence 820 of sets of feature data including a first set 822, a second set 824, and one or more additional sets including an Nth set 826. Each set of feature data can include or correspond to a latent-space representation (e.g., the latent-space representation 212 of any of FIG. 2-5), or an error value based on a latent-space representation (such as a divergence value 322, a reconstruction error value 324, or both).

The classifier 120 is configured to receive the sequence 820 of sets of feature data (and optionally other data) and to output a sequence of segment classifications 220 based on the feature data in the sequence 820. For example, the sequence of segment classifications 220 can include a first segment classification (C1) 832 indicating a classification assigned to the first frame 812, a second segment classification (C2) 834 indicating a classification assigned to the second frame 812, and an Nth segment classification (CN) 836 indicating a classification assigned to the Nth frame 812.

FIG. 9 depicts an embodiment 900 of the device 102 of FIG. 1A as an integrated circuit 902 that includes the one or more processors 190. The integrated circuit 902 also includes a signal input 904, such as one or more bus interfaces, to enable the time-series data 110 to be received for processing. In FIG. 9, the processor(s) 190 include the processing controller 140, the downstream processing components 142, or both. The integrated circuit 902 also includes a signal output 906, such as a bus interface, to enable sending of an output data 908, such as the processing control signal 122 of FIG. 1, the segment classification 220 of FIG. 2, or a result of processing of a segment of the time-series data 110 by a selected subset of the downstream processing component 142.

FIG. 10 depicts an embodiment 1000 in which the device 102 includes a mobile device 1002, such as a phone or tablet, as illustrative, non-limiting examples. The mobile device 1002 includes a microphone 1004, a camera 1006, and a display screen 1008. The microphone 1004, the camera 1006, or both, can be configured to generate time-series data (e.g., the time-series data 110 of FIG. 1). Additionally, or alternatively, the mobile device 1002 can include other sensors (e.g., an inertial measurement unit, a pressure sensor, a temperature sensor, etc.) configured to generate the time-series data. Components of the processor(s) 190, including the processing controller 140 and the downstream processing components 142, are integrated in the mobile device 1002 and are illustrated using dashed lines to indicate internal components that are not generally visible to a user of the mobile device 1002.

In a particular example, the processing controller 140 is configured to determine whether each segment of the time-series data includes target data (e.g., data of a target data type) and to generate a processing control signal based on the determination. The downstream processing components 142 are configured to perform particular operations on the segments of the time-series data responsive to the processing control signals. For example, the downstream processing components 142 can perform a first set of one or more operations on each segment that includes target data, and perform a second set of one or more operations on each segment that does not include target data. To illustrate, the target data type can include speech, in which case the downstream processing components 142 can process segments that includes speech using the first set of operations and can process segments of that do not include speech using the second set of operations. In this illustrative example, the first set of operations can be better suited for processing speech containing segments than are the second set of operations (based on a particular design goal). As a non-limiting example, the first set of operations can include a speech encoder and the second set of operations can include a general-purpose encoder. In this example, the speech encoder can be better (in terms of efficiency, fidelity, or some other metric) at encoding speech than the general-purpose encoder is.

FIG. 11 depicts an embodiment 1100 in which the device 102 includes a headset device 1102. The headset device 1102 includes a microphone 1104 and a speaker 1106. The microphone 1104 can be configured to generate time-series data (e.g., the time-series data 110 of FIG. 1). Additionally, or alternatively, the headset device 1102 can include other sensors (e.g., a camera, an inertial measurement unit, a pressure sensor, a temperature sensor, etc.) configured to generate the time-series data. Components of the processor(s) 190, including the processing controller 140 and the downstream processing components 142, are integrated in the headset device 1102. In a particular example, the processing controller 140 is configured to determine whether each segment of the time-series data includes target data (e.g., data of a target data type) and to generate a processing control signal based on the determination. The downstream processing components 142 are configured to perform particular operations on the segments of the time-series data responsive to the processing control signals. For example, the downstream processing components 142 can perform a first set of one or more operations on each segment that includes target data, and perform a second set of one or more operations on each segment that does not include target data. To illustrate, the target data type can include speech, in which case the downstream processing components 142 can process segments that includes speech using the first set of operations and can process segments of that do not include speech using the second set of operations.

FIG. 12 depicts an embodiment 1200 in which the device 102 includes a wearable electronic device 1202, illustrated as a “smart watch.” The wearable electronic device 1202 includes a microphone 1204, a sensor 1206, and a display 1208. The microphone 1204, the sensor 1206, or both, can be configured to generate time-series data (e.g., the time-series data 110 of FIG. 1). For example, the sensor 1206 can include a camera, one or more physiological sensors (e.g., a heart rate monitor, a blood oxygen sensor), a movement sensor, or one or more other types of sensors configured to generate the time-series data. Components of the processor(s) 190, including the processing controller 140 and the downstream processing components 142, are integrated in the wearable electronic device 1202. In a particular example, the processing controller 140 is configured to determine whether each segment of the time-series data includes target data (e.g., data of a target data type) and to generate a processing control signal based on the determination. The downstream processing components 142 are configured to perform particular operations on the segments of the time-series data responsive to the processing control signals. For example, when the sensor 1206 includes one or more physiological sensors, the downstream processing components 142 can perform a first set of one or more operations on each segment that includes target physiological data (e.g., a target heart rhythm) and perform a second set of one or more operations on each segment that does not include the target data.

FIG. 13 depicts an embodiment 1300 in which the device 102 includes a portable electronic device that corresponds to augmented reality or mixed reality glasses 1302. The glasses 1302 include a holographic projection unit 1308 configured to project visual data onto a surface of a lens 1310 or to reflect the visual data off of a surface of the lens 1310 and onto the wearer's retina. The glasses 1302 also include a microphone 1306 and a camera 1304. The microphone 1306, the camera 1304, or both, can be configured to generate time-series data (e.g., the time-series data 110 of FIG. 1). Additionally, or alternatively, the glasses 1302 can include other sensors (e.g., an inertial measurement unit, a pressure sensor, a temperature sensor, etc.) configured to generate the time-series data.

Components of the processor(s) 190, including the processing controller 140 and the downstream processing components 142, are integrated in the glasses 1302. In a particular example, the processing controller 140 is configured to determine whether each segment of the time-series data includes target data (e.g., data of a target data type) and to generate a processing control signal based on the determination. The downstream processing components 142 are configured to perform particular operations on the segments of the time-series data responsive to the processing control signals. For example, the camera 1304 can generate a series of images corresponding to the time-series data. In this example, when a particular image includes a face, the downstream processing components 142 can perform operations to identify the face and send output to the holographic projection unit 1308 to cause the name to be displayed to a user of the glasses 1302.

FIG. 14 depicts an embodiment 1400 in which the device 102 includes a portable electronic device that corresponds to a pair of earbuds 1410 that includes a first earbud 1402A and a second earbud 1402B. Although earbuds 1410 are described, it should be understood that the present technology can be applied to other in-ear or over-ear playback devices.

The first earbud 1402A includes a first microphone 1404, such as a high signal-to-noise microphone positioned to capture the voice of a wearer of the first earbud 1402A, an array of one or more other microphones configured to detect ambient sounds and spatially distributed to support beamforming, illustrated as microphones 1422A, 1422B, and 1422C, an “inner” microphone 1424 proximate to the wearer's ear canal (e.g., to assist with active noise cancelling), and a self-speech microphone 1426, such as a bone conduction microphone configured to convert sound vibrations of the wearer's ear bone or skull into an audio signal. The second earbud 1402B can be configured in a substantially similar manner as the first earbud 1402A.

In FIG. 14, the first earbud 1402A includes components of the processor(s) 190, including the processing controller 140 and the downstream processing components 142. The processing controller 140 is configured to process time-series data to generate processing control signals for the downstream processing components 142. The time-series data can correspond to or include data captured by any combination of the microphones 1404, 1422A, 1422B, 1422C, 1424, and 1426 or other sensors of the earbuds 1410. The downstream processing components 142 are configured to perform particular operations on the segments of the time-series data responsive to the processing control signals. For example, the target data type can include speech, in which case the downstream processing components 142 can process segments that includes speech using a first set of operations and can process segments of that do not include speech using a second set of operations.

In some embodiments, the earbuds 1402A, 1402B are configured to automatically switch between various operating modes, such as a passthrough mode in which ambient sound is played via a speaker 1406, a playback mode in which non-ambient sound (e.g., streaming audio corresponding to a phone conversation, media playback, video game, etc.) is played back through the speaker 1406, and an audio zoom mode or beamforming mode in which one or more ambient sounds are emphasized and/or other ambient sounds are suppressed for playback at the speaker 1406. In such embodiments, the downstream processing components 142 can switch between such modes based on the processing control signals from the processing controller 140. For example, when speech is detected in sound captured by one or more of microphones 1404, 1422A, 1422B, 1422C, 1424, 1426, the downstream processing components 142 can activate a first mode and when no speech is detected in sound captured by the microphones 1404, 1422A, 1422B, 1422C, 1424, 1426, the downstream processing components 142 can activate a second mode.

FIG. 15 is an embodiment 1500 in which the device 102 includes a wireless speaker and voice activated device 1502. The wireless speaker and voice activated device 1502 can have wireless network connectivity and is configured to execute an assistant operation. The wireless speaker and voice activated device 1502 includes a microphone 1504 and a speaker 1506. The microphone 1504 can be configured to generate time-series data (e.g., the time-series data 110 of FIG. 1). Additionally, or alternatively, the wireless speaker and voice activated device 1502 can include other sensors (e.g., a camera, a pressure sensor, a temperature sensor, etc.) configured to generate the time-series data. Components of the processor(s) 190, including the processing controller 140 and the downstream processing components 142, are integrated in wireless speaker and voice activated device 1502.

In a particular example, the processing controller 140 is configured to determine whether each segment of the time-series data includes target data (e.g., data of a target data type) and to generate a processing control signal based on the determination. The downstream processing components 142 are configured to perform particular operations on the segments of the time-series data responsive to the processing control signals. For example, the target data type can include speech, in which case the downstream processing components 142 can process segments that includes speech using the first set of operations and can process segments of that do not include speech using the second set of operations. To illustrate, a keyword detector associated with voice assistant operations may be activated only in response to detection of speech in audio captured by the microphone 1504. To illustrate, when the processing controller 140 does not detect speech in the audio data from the microphone 1504, the processing control signal from the processing controller 140 can cause the downstream processing components 142 to deactivate the voice assistant operations (including the keyword detector). However, when the processing controller 140 detects speech in the audio data from the microphone 1504, the processing control signal from the processing controller 140 causes the downstream processing components 142 to activate the keyword detector of the voice assistant operations.

FIG. 16 depicts an embodiment 1600 in which the device 102 includes a portable electronic device that corresponds to a camera device 1602. The camera device 1602 includes a microphone 1104 and an image sensor 1606. The microphone 1604, the image sensor 1606, or both, can be configured to generate time-series data (e.g., the time-series data 110 of FIG. 1). Additionally, or alternatively, the camera device 1602 can include other sensors (e.g., an inertial measurement unit, a pressure sensor, a temperature sensor, etc.) configured to generate the time-series data. Components of the processor(s) 190, including the processing controller 140 and the downstream processing components 142, are integrated in the camera device 1602. In a particular example, the processing controller 140 is configured to determine whether each segment of the time-series data includes target data (e.g., data of a target data type) and to generate a processing control signal based on the determination. The downstream processing components 142 are configured to perform particular operations on the segments of the time-series data responsive to the processing control signals. For example, the downstream processing components 142 can perform a first set of one or more operations on each segment that includes target data, and perform a second set of one or more operations on each segment that does not include target data.

FIG. 17 depicts an embodiment 1700 in which the device 102 includes a portable electronic device that corresponds to an extended reality (XR) headset 1702, such as a virtual reality, mixed reality, or augmented reality headset. The XR headset 1702 includes a microphone 1704. The microphone 1104 can be configured to generate time-series data (e.g., the time-series data 110 of FIG. 1). Additionally, or alternatively, the XR headset 1702 can include other sensors (e.g., a camera, an inertial measurement unit, a pressure sensor, a temperature sensor, etc.) configured to generate the time-series data. Components of the processor(s) 190, including the processing controller 140 and the downstream processing components 142, are integrated in the XR headset 1702. In a particular example, the processing controller 140 is configured to determine whether each segment of the time-series data includes target data (e.g., data of a target data type) and to generate a processing control signal based on the determination. The downstream processing components 142 are configured to perform particular operations on the segments of the time-series data responsive to the processing control signals. For example, the downstream processing components 142 can perform a first set of one or more operations on each segment that includes target data, and perform a second set of one or more operations on each segment that does not include target data. To illustrate, the target data type can include speech, in which case the downstream processing components 142 can process segments that includes speech using the first set of operations and can process segments of that do not include speech using the second set of operations.

FIG. 18 depicts an embodiment 1800 in which the device 102 corresponds to, or is integrated within, a vehicle 1802, illustrated as a manned or unmanned aerial device (e.g., a package delivery drone). The vehicle 1802 includes a microphone 1804 and a camera 1806. The microphone 1804, the camera 1806, or both, can be configured to generate time-series data (e.g., the time-series data 110 of FIG. 1). Additionally, or alternatively, the vehicle 1802 can include other sensors (e.g., an inertial measurement unit, a pressure sensor, a temperature sensor, etc.) configured to generate the time-series data. Components of the processor(s) 190, including the processing controller 140 and the downstream processing components 142, are integrated in the vehicle 1802. In a particular example, the processing controller 140 is configured to determine whether each segment of the time-series data includes target data (e.g., data of a target data type) and to generate a processing control signal based on the determination. The downstream processing components 142 are configured to perform particular operations on the segments of the time-series data responsive to the processing control signals. For example, the downstream processing components 142 can perform a first set of one or more operations on each segment that includes target data, and perform a second set of one or more operations on each segment that does not include target data. To illustrate, user voice activity detection can be performed by the downstream processing components 142 based on the processing controller 140 determining that an image from the camera 1806 includes a face, based on the processing controller 140 determining that sound captured by the microphone 1804 includes speech, or both.

FIG. 19 depicts another embodiment 1900 in which the device 102 corresponds to, or is integrated within, a vehicle 1902, illustrated as a car. The vehicle 1902 includes the processing controller 140 and the downstream processing component 142. The vehicle 1902 also includes the one or more microphones 1904, one or more sensors 1906 (e.g., cameras, LiDAR systems, internal measurement units, etc.), or a combination thereof, configured to generate time-series data (e.g., the time-series data 110 of FIG. 1). The processing controller 140 is configured to determine whether each segment of the time-series data includes target data and to generate a processing control signal based on the determination. The downstream processing components 142 are configured to perform particular operations on the segments of the time-series data responsive to the processing control signals. For example, the downstream processing components 142 can perform a first set of one or more operations on each segment that includes target data, and perform a second set of one or more operations on each segment that does not include target data. To illustrate, the target data type can include speech, in which case the downstream processing components 142 can process segments that includes speech using the first set of operations and can process segments of that do not include speech using the second set of operations.

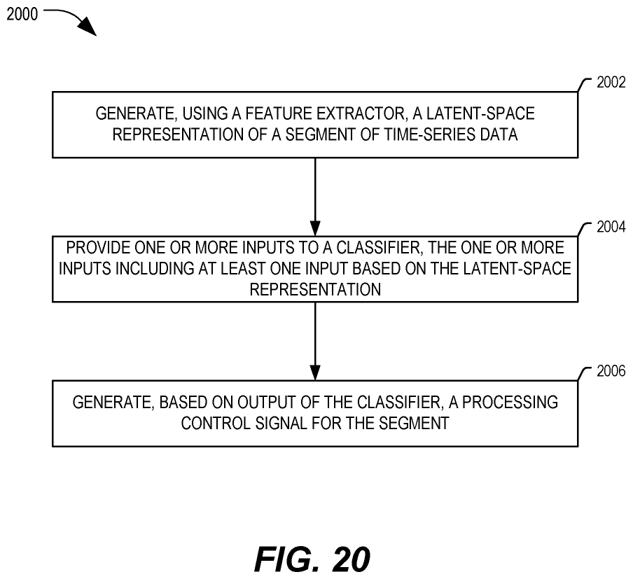

Referring to FIG. 20, a particular embodiment of a method 2000 of selectively processing time-series data is shown. In a particular aspect, one or more operations of the method 2000 are performed by at least one of the processing controller 140, the downstream processing components 142, the processor 190, the device 102, the system 100 of FIG. 1, or a combination thereof.

The method 2000 includes, at block 2002, generating, using a feature extractor, a latent-space representation of a segment of time-series data. For example, the processor(s) 190 can execute the instructions 194 to perform the operations described with reference to the processing controller 140, such as generating segment data 114 based on the time-series data 110 and providing the segment data 114 as input to the feature extractor 116 to generate a latent-space representation of the segment data 114 (such as the latent-space representation 212 of any of FIGS. 2-5).

In some embodiments, the feature extractor includes an autoencoder, which includes an inference network portion, a bottleneck layer, and a generation network portion. The inference network portion, the generation network portion, or both, may include one or more recurrent layers, one or more dilated convolution layers, one or more temporally dynamic layers, or any combination thereof. In some embodiments, the autoencoder is a variational autoencoder, in which case the latent-space representation includes a mean and a standard deviation of a probability distribution.

The autoencoder of the feature extractor may be trained to reproduce data segments from a target signal class. For example, the target signal class can include audio data that includes speech, in which case the autoencoder is trained to reproduce speech data. In embodiments in which the time-series data represents audio data, a segment of the time-series data can include an audio frame, and the segment data can include a spectral representation of one or more audio data samples of the audio frame.

The method 2000 includes, at block 2004, providing one or more inputs to a classifier. The classifier can include, for example, a one-class classifier or a binary classifier, and output of the classifier indicates whether the segment is assigned to a target signal class.

The one or more inputs to the classifier include at least one input based on the latent-space representation from the feature extractor. For example, at least one of the one or more inputs provided to the classifier can include the latent-space representation. As another example, at least one of the one or more inputs to the classifier can include an error value. To illustrate, in some embodiments, the feature extractor includes a generation network portion, and input based on the latent-space representation is provided to the generation network portion to generate a synthesized segment of time-series data. In such embodiments, the error value can be determined based on comparison of the segment and the synthesized segment. The error value can be determined, for example, as an Itakura-Saito distance based on the segment and the synthesized segment, as a scale-invariant signal-to-distortion ratio based on the segment and the synthesized segment, as a log Spectral Distortion value based on the segment and the synthesized segment, etc. In embodiments in which the feature extractor includes a VAE, the latent-space representation defines a probability distribution, which is normalized to an expected probability distribution during training. In such embodiments, output of the generation network portion can include or be mapped to a probability distribution, and the error value can be determined based on the expected probability distribution and the probability distribution of the output.

In some embodiments, the one or more inputs to the classifier can also include a mode indicator associated with the segment. In such embodiments, the mode indicator can indicate, for example, whether the segment represents voiced speech. As another example, the mode indicator can indicate whether the segment represents music. The mode indicator can be determined using relatively light-weight operations, such as by performing a statistical analysis of the time-series data and generating the mode indicator based on results of the statistical analysis. As another example, the mode indicator can include an Enhanced Variable Rate Codec (EVRC) mode decision based on the segment.

In some embodiments, the one or more inputs to the classifier can also include one or more features associated with the segment, such as open loop pitch, normalized correlation, spectral envelope, tonal stability, signal non-stationarity, linear prediction residual error, spectral difference, spectral stationarity, or a combination thereof.

The method 2000 includes, at block 2006, generating, based on output of the classifier, a processing control signal for the segment. The processing control signal indicates which of a set of available operations are performed on the segment of the time-series data. For example, when the time-series data represents audio content, the output of the classifier can indicate whether the segment includes an audio data type associated with a first audio encoder. In this example, the processing control signals may cause the segment to be selectively routed to one of two or more available audio encoders, such as to the first audio encoder if the segment includes the audio data type associated with the first audio encoder, or to a second audio encoder if the segment does not include the audio data type associated with the first audio encoder.

Thus, based on the processing control signal, either first encoding operations or second encoding operations are performed to encode the segment. In this example, as compared to the second encoding operations, the first encoding operations may provide higher quality encoding of the target signal class than do the second encoding operations, more efficient encoding of the target signal class than do the second encoding operations, or both.

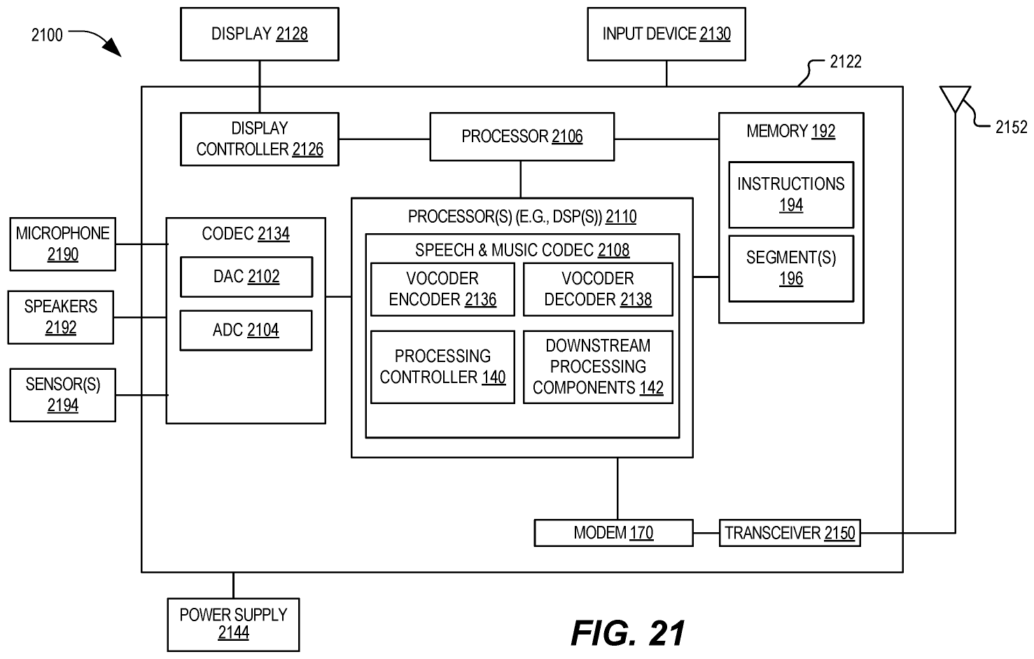

The method 2000 of FIG. 20 may be implemented by a field-programmable gate array (FPGA) device, an application-specific integrated circuit (ASIC), a processing unit such as a central processing unit (CPU), a DSP, a controller, another hardware device, firmware device, or any combination thereof. As an example, the method 2000 of FIG. 20 may be performed by a processor that executes instructions, such as described with reference to FIG. 21.

Referring to FIG. 21, a block diagram of a particular illustrative embodiment of a device is depicted and generally designated 2100. In various embodiments, the device 2100 may have more or fewer components than illustrated in FIG. 21. In an illustrative embodiment, the device 2100 may correspond to the device 102. In an illustrative embodiment, the device 2100 may perform one or more operations described with reference to FIGS. 1A-20.

In a particular embodiment, the device 2100 includes a processor 2106 (e.g., a central processing unit (CPU)). The device 2100 may include one or more additional processors 2110 (e.g., one or more DSPs). In a particular aspect, the processor(s) 190 of FIG. 1A correspond to the processor 2106, the processors 2110, or a combination thereof. The processors 2110 may include a speech and music coder-decoder (CODEC) 2108 that includes a voice coder (“vocoder”) encoder 2136, a vocoder decoder 2138, the processing controller 140, the downstream processing components 142, or a combination thereof.

The device 2100 may include the memory 192 and a CODEC 2134. The memory 192 may include the instructions 152, which are executable by the one or more additional processors 2110 (or the processor 2106) to implement the functionality described with reference to the processing controller 140, the downstream processing components 142, or both. The memory 192 may also store segment(s) 196 of the time-series data 110 of FIG. 1. The device 2100 may include the modem 170 coupled, via a transceiver 2150, to an antenna 2152.

The device 2100 may include a display 2128 coupled to a display controller 2126. A microphone 2190, a speaker 2192, one or more sensors 2194, or a combination thereof, may be coupled to the CODEC 2134. The CODEC 2134 may include a digital-to-analog converter (DAC) 2102, an analog-to-digital converter (ADC) 2104, or both. In a particular embodiment, the CODEC 2134 may receive analog signals from the microphone 2190 and the sensor(s) 2194, or both, convert the analog signals to digital signals using the analog-to-digital converter 2104, and provide the digital signals to the processor(s) 2110, the processor 2106, or both (such as to the speech and music codec 2108). The digital signals may be processed by the processing controller 140 and at least a subset of the downstream processing components 142. The speech and music codec 2108 may provide digital signals to the CODEC 2134. The CODEC 2134 may convert the digital signals to analog signals using the digital-to-analog converter 2102 and may provide the analog signals to the speaker 2192.

In a particular embodiment, the device 2100 may be included in a system-in-package or system-on-chip device 2122. In a particular embodiment, the memory 150, the processor 2106, the processors 2110, the display controller 2126, the CODEC 2134, and the modem 170 are included in the system-in-package or system-on-chip device 2122. In a particular embodiment, an input device 2130 and a power supply 2144 are coupled to the system-in-package or the system-on-chip device 2122. Moreover, in a particular embodiment, as illustrated in FIG. 21, the display 2128, the input device 2130, the speaker 2192, the microphone 2190, the sensor(s) 2194, the antenna 2152, and the power supply 2144 are external to the system-in-package or the system-on-chip device 2122. In a particular embodiment, each of the display 2128, the input device 2130, the speaker 2192, the microphone 2190, the sensor(s) 2194, the antenna 2152, and the power supply 2144 may be coupled to a component of the system-in-package or the system-on-chip device 2122, such as an interface (e.g., the input interface 108) or a controller.

The device 2100 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, a virtual reality headset, an aerial vehicle, a home automation system, a voice-activated device, a wireless speaker and voice activated device, a portable electronic device, a car, a computing device, a communication device, an internet-of-things (IoT) device, an extended reality (XR) device, a base station, a mobile device, or any combination thereof.

In conjunction with the described embodiments, an apparatus includes means for generating a latent-space representation of a segment of time-series data. For example, the means for generating the latent-space representation of the segment of time-series data can correspond to the system 100, the device 102, the processor(s) 190, the processing controller 140, the feature extractor 116, the autoencoder 200, the inference network portion 204 and the bottleneck layer 206, the feature extractor 608, the integrated circuit 902, one or more other circuits or components configured to generate a latent-space representation of a segment of time-series data, or any combination thereof.

The apparatus also includes means for providing one or more inputs to a classifier, where the one or more inputs include at least one input based on the latent-space representation. For example, the means for providing one or more inputs to the classifier can correspond to the system 100, the device 102, the processor(s) 190, the processing controller 140, the feature extractor 116, the pre-processor 112, the autoencoder 200, the inference network portion 204 and the bottleneck layer 206, the mode detector 304, the divergence calculator 312, the reconstruction error calculator 314, the audio mode detector 404, the feature extractor 608, the error calculator(s) 610, the error calculator(s) 626, the integrated circuit 902, one or more other circuits or components configured to provide one or more inputs to the classifier, or any combination thereof.

The apparatus also includes means for generating a processing control signal for the segment. For example, the means for generating a processing control signal for the segment can correspond to the system 100, the device 102, the processor(s) 190, the processing controller 140, the classifier 120, the audio classifier 420, the integrated circuit 902, one or more other circuits or components configured to generate a processing control signal for the segment, or any combination thereof.

In some embodiments, a non-transitory computer-readable medium (e.g., a computer-readable storage device, such as the memory 150) includes instructions (e.g., the instructions 152) that, when executed by one or more processors (e.g., the one or more processors 2110 or the processor 2106 or the processor(s) 190), cause the one or more processors to generate, using a feature extractor, a latent-space representation of a segment of time-series data; provide one or more inputs to a classifier, the one or more inputs including at least one input based on the latent-space representation; and generate, based on output of the classifier, a processing control signal for the segment.

Particular aspects of the disclosure are described below in sets of interrelated Examples:

According to Example 1, a device includes a memory configured to store one or more segments of time-series data; and one or more processors configured to generate, using a feature extractor, a latent-space representation of a segment of the time-series data; provide one or more inputs to a classifier, the one or more inputs including at least one input based on the latent-space representation; and generate, based on output of the classifier, a processing control signal for the segment.

Example 2 includes the device of Example 1, wherein the classifier is a one-class classifier or a binary classifier and the output indicates whether the segment is assigned to a target signal class.

Example 3 includes the device of Example 1 or Example 2, wherein the one or more processors are configured to selectively, based on the processing control signal, perform first encoding operations to encode the segment or perform second encoding operations to encode the segment, wherein the first encoding operations provide higher quality encoding of the target signal class than do the second encoding operations.

Example 4 includes the device of any of Examples 1 to 3, wherein the one or more processors are configured to selectively, based on the processing control signal, perform first encoding operations to encode the segment or perform second encoding operations to encode the segment, wherein the first encoding operations provide more efficient encoding of the target signal class than do the second encoding operations.

Example 5 includes the device of any of Examples 1 to 4, wherein the time-series data represents audio content, and wherein the output indicates whether the segment includes an audio data type associated with a first audio encoder.

Example 6 includes the device of any of Examples 1 to 5, wherein the one or more processors are configured to selectively route the segment to one of two or more audio coders based on the processing control signal.

Example 7 includes the device of any of Examples 1 to 6, wherein the segment corresponds to a segment of audio data and the input to the feature extractor includes a frequency-domain representation of the segment of audio data.

Example 8 includes the device of Example 7, wherein the frequency-domain representation includes a power spectrum of the segment of audio data.

Example 9 includes the device of any of Examples 1 to 8, wherein the feature extractor includes an inference network portion and a generation network portion of an autoencoder.

Example 10 includes the device of Example 9, wherein the autoencoder includes one or more recurrent layers.

Example 11 includes the device of Example 9 or Example 10, wherein the autoencoder includes one or more dilated convolution layers.

Example 12 includes the device of any of Examples 9 to 11, wherein the autoencoder includes one or more temporally dynamic layers.

Example 13 includes the device of any of Examples 9 to 12, wherein the autoencoder is a variational autoencoder and the latent-space representation includes a mean and a standard deviation of a probability distribution.

Example 14 includes the device of any of Examples 9 to 13, wherein the autoencoder is trained to reproduce data segments from a target signal class, and the classifier is configured to distinguish the data segments from the target signal class and data segments that are not from the target signal class based on separation of latent-space representations between the data segments from the target signal class and the data segments that are not from the target signal class.

Example 15 includes the device of any of Examples 9 to 14, wherein the autoencoder is trained to reproduce speech data, and the classifier is configured to distinguish audio data segments that include speech from audio data segments that do not include speech.

Example 16 includes the device of any of Examples 9 to 15, wherein the one or more processors are configured to provide input, based on the latent-space representation, to the generation network portion to generate a synthesized segment of time-series data; and determine a reconstruction error value based on comparison of the segment and the synthesized segment, wherein at least one of the one or more inputs provided to the classifier is based on the reconstruction error value.

Example 17 includes the device of Example 16, wherein determining the error value includes calculating an Itakura-Saito distance based on the segment and the synthesized segment.

Example 18 includes the device of Example 16, wherein determining the error value includes calculating a scale-invariant signal-to-distortion ratio based on the segment and the synthesized segment.

Example 19 includes the device of Example 16, wherein determining the error value includes calculating a log Spectral Distortion value based on the segment and the synthesized segment.

Example 20 includes the device of any of Examples 9 to 19, wherein the one or more processors are configured to provide input, based on the latent-space representation, to the generation network portion to generate a probability distribution; and determine an error value based on the probability distribution, wherein at least one of the one or more inputs provided to the classifier is based on the error value.

Example 21 includes the device of any of Examples 2 to 20, wherein at least one of the one or more inputs provided to the classifier includes the latent-space representation.

Example 22 includes the device of any of Examples 1 to 21, wherein the one or more processors are configured to determine a divergence metric indicating differences between a probability distribution of the latent-space representation and an expected probability distribution, and wherein at least one of the one or more inputs provided to the classifier is based on the divergence metric.

Example 23 includes the device of any of Examples 1 to 22, wherein the one or more processors are configured to determine a mode indicator associated with the segment, and wherein at least one of the one or more inputs provided to the classifier is based on the mode indicator.

Example 24 includes the device of Example 23, wherein the mode indicator indicates whether the segment represents voiced speech.

Example 25 includes the device of Example 23 or Example 24, wherein the mode indicator indicates whether the segment represents music.

Example 26 includes the device of any of Examples 23 to 25, wherein the mode indicator is based on a statistical analysis of the time-series data.

Example 27 includes the device of any of Examples 1 to 26, wherein the one or more processors are configured to determine one or more features associated with the segment, and wherein at least one of the one or more inputs provided to the classifier is based on the one or more features.

Example 28 includes the device of Example 27, wherein the one or more features include one or more of open loop pitch, normalized correlation, spectral envelope, tonal stability, signal non-stationarity, linear prediction residual error, spectral difference, and spectral stationarity.

Example 29 includes the device of any of Examples 1 to 28, wherein the one or more processors are configured to generate an Enhanced Variable Rate Codec (EVRC) mode decision based on the segment, and wherein at least one of the one or more inputs provided to the classifier is based on the EVRC mode decision.

Example 30 includes the device of any of Examples 1 to 29, wherein the feature extractor includes a first machine-learning model that is trained, based on training data, to synthesize time-series data approximating input time-series data.

Example 31 includes the device of Example 30, wherein each segment of the training data includes speech.

Example 32 includes the device of Example 30, wherein the training data includes segments representing speech and segments representing non-speech sounds.

Example 33 includes the device of Example 30, wherein each segment of the training data includes data assigned to a target signal class.

Example 34 includes the device of Example 30, wherein the training data includes data assigned to a target signal class and data that are not assigned to the target signal class.

Example 35 includes the device of any of Examples 30 to 34, wherein the classifier is trained using labeled training data that is based on outputs of the feature extractor.

Example 36 includes the device of any of Examples 30 to 35, wherein the classifier includes a second machine-learning model, and wherein the first and second machine-learning models are jointly trained.

According to Example 37, a method includes generating, using a feature extractor, a latent-space representation of a segment of time-series data; providing one or more inputs to a classifier, the one or more inputs including at least one input based on the latent-space representation; and generating, based on output of the classifier, a processing control signal for the segment.

Example 38 includes the method of Example 37, wherein the classifier is a one-class classifier or a binary classifier and the output indicates whether the segment is assigned to a target signal class.

Example 39 includes the method of Example 37 or Example 38 and further includes selectively, based on the processing control signal, performing first encoding operations to encode the segment or performing second encoding operations to encode the segment, wherein the first encoding operations provide higher quality encoding of the target signal class than do the second encoding operations.

Example 40 includes the method of any of Examples 37 to 39 and further includes selectively, based on the processing control signal, performing first encoding operations to encode the segment or performing second encoding operations to encode the segment, wherein the first encoding operations provide more efficient encoding of the target signal class than do the second encoding operations.

Example 41 includes the method of any of Examples 37 to 40, wherein the time-series data represents audio content, and wherein the output indicates whether the segment includes an audio data type associated with a first audio encoder.

Example 42 includes the method of any of Examples 37 to 41 and further includes selectively routing the segment to an audio encoder based on the processing control signal.

Example 43 includes the method of any of Examples 37 to 42, wherein the segment corresponds to an audio frame including spectral representations of one or more audio data samples.

Example 44 includes the method of any of Examples 37 to 43, wherein the feature extractor includes an inference network portion and generation network portion of an autoencoder.

Example 45 includes the method of Example 44, wherein the autoencoder includes one or more recurrent layers.

Example 46 includes the method of Example 44 or Example 45, wherein the autoencoder includes one or more dilated convolution layers.

Example 47 includes the method of any of Examples 44 to 46, wherein the autoencoder includes one or more temporally dynamic layers.

Example 48 includes the method of any of Examples 44 to 47, wherein the autoencoder is a variational autoencoder and the latent-space representation includes a mean and a standard deviation of a probability distribution.

Example 49 includes the method of any of Examples 44 to 48, wherein the autoencoder is trained to reproduce data segments from a target signal class, and the classifier is configured to distinguish the data segments from the target signal class and data segments that are not from the target signal class based on separation of latent-space representations between the data segments from the target signal class and the data segments that are not from the target signal class.

Example 50 includes the method of any of Examples 44 to 49, wherein the autoencoder is trained to reproduce speech data, and the classifier is configured to distinguish audio data segments that include speech from audio data segments that do not include speech.

Example 51 includes the method of any of Examples 44 to 50 and further includes providing input, based on the latent-space representation, to the generation network portion to generate a synthesized segment of time-series data; and determining an error value based on comparison of the segment and the synthesized segment, wherein at least one of the one or more inputs provided to the classifier is based on the error value.

Example 52 includes the method of Example 51, wherein determining the error value includes calculating an Itakura-Saito distance based on the segment and the synthesized segment.

Example 53 includes the method of Example 51, wherein determining the error value includes calculating a scale-invariant signal-to-distortion ratio based on the segment and the synthesized segment.

Example 54 includes the method of Example 51, wherein determining the error value includes calculating a log Spectral Distortion value based on the segment and the synthesized segment.

Example 55 includes the method of any of Examples 44 to 54 and further includes providing input, based on the latent-space representation, to the generation network portion to generate a probability distribution; and determining an error value based on the segment and the probability distribution, wherein at least one of the one or more inputs provided to the classifier is based on the error value.

Example 56 includes the method of any of Examples 37 to 55, wherein at least one of the one or more inputs provided to the classifier includes the latent-space representation.

Example 57 includes the method of any of Examples 37 to 56 and further includes determining a divergence metric indicating differences between a probability distribution of the latent-space representation and an expected probability distribution, and wherein at least one of the one or more inputs provided to the classifier is based on the divergence metric.

Example 58 includes the method of any of Examples 37 to 57 and further includes determining a mode indicator associated with the segment, and wherein at least one of the one or more inputs provided to the classifier is based on the mode indicator.

Example 59 includes the method of Example 58, wherein the mode indicator indicates whether the segment represents voiced speech.

Example 60 includes the method of Example 58 or Example 59, wherein the mode indicator indicates whether the segment represents music.

Example 61 includes the method of any of Examples 58 to 60 and further includes performing a statistical analysis of the time-series data and generating the mode indicator based on the statistical analysis.

Example 62 includes the method of any of Examples 37 to 61 and further includes determining one or more features associated with the segment, and wherein at least one of the one or more inputs provided to the classifier is based on the one or more features.

Example 63 includes the method of Example 62, wherein the one or more features include one or more of open loop pitch, normalized correlation, spectral envelope, tonal stability, signal non-stationarity, linear prediction residual error, spectral difference, and spectral stationarity.

Example 64 includes the method of any of Examples 37 to 63 and further includes generating an Enhanced Variable Rate Codec (EVRC) mode decision based on the segment, and wherein at least one of the one or more inputs provided to the classifier is based on the EVRC mode decision.

Example 65 includes the method of any of Examples 37 to 64, wherein the feature extractor includes a first machine-learning model that is trained, based on training data, to synthesize time-series data approximating input time-series data.

Example 66 includes the method of Example 65, wherein each segment of the training data includes speech.

Example 67 includes the method of Example 65, wherein the training data includes segments representing speech and segments representing non-speech sounds.

Example 68 includes the method of Example 65, wherein each segment of the training data includes data assigned to a target signal class.

Example 69 includes the method of Example 65, wherein the training data includes segments assigned to data assigned to a target signal class and data that are not assigned to the target signal class.

Example 70 includes the method of Example 65, wherein the classifier is trained using labeled training data that is based on outputs of the feature extractor.

Example 71 includes the method of Example 65, wherein the classifier includes a second machine-learning model, and wherein the first and second machine-learning models are jointly trained.

According to Example 72, a non-transitory computer-readable medium storing instructions that are executable by one or more processors to cause the one or more processors to generate, using a feature extractor, a latent-space representation of a segment of time-series data; provide one or more inputs to a classifier, the one or more inputs including at least one input based on the latent-space representation; and generate, based on output of the classifier, a processing control signal for the segment.

Example 73 includes the non-transitory computer-readable medium of Example 72, wherein the classifier is a one-class classifier or a binary classifier and the output indicates whether the segment is assigned to a target signal class.

Example 74 includes the non-transitory computer-readable medium of Example 72 or Example 73, wherein the instructions further cause the one or more processors to selectively, based on the processing control signal, perform first encoding operations to encode the segment or perform second encoding operations to encode the segment, wherein the first encoding operations provide higher quality encoding of the target signal class than do the second encoding operations.

Example 75 includes the non-transitory computer-readable medium of any of Examples 72 to 74, wherein the instructions further cause the one or more processors to selectively, based on the processing control signal, perform first encoding operations to encode the segment or perform second encoding operations to encode the segment, wherein the first encoding operations provide more efficient encoding of the target signal class than do the second encoding operations.

Example 76 includes the non-transitory computer-readable medium of any of Examples 72 to 75, wherein the time-series data represents audio content, and wherein the output indicates whether the segment includes an audio data type associated with a first audio encoder.

Example 77 includes the non-transitory computer-readable medium of any of Examples 72 to 76, wherein the instructions further cause the one or more processors to selectively route the segment to an audio encoder based on the processing control signal.

Example 78 includes the non-transitory computer-readable medium of any of Examples 72 to 77, wherein the segment corresponds to an audio frame including spectral representations of one or more audio data samples.

Example 79 includes the non-transitory computer-readable medium of any of Examples 72 to 78, wherein the feature extractor includes an inference network portion and generation network portion of an autoencoder.

Example 80 includes the non-transitory computer-readable medium of Example 79, wherein the autoencoder includes one or more recurrent layers.

Example 81 includes the non-transitory computer-readable medium of Example 79 or Example 80, wherein the autoencoder includes one or more dilated convolution layers.

Example 82 includes the non-transitory computer-readable medium of any of Examples 79 to 81, wherein the autoencoder includes one or more temporally dynamic layers.

Example 83 includes the non-transitory computer-readable medium of any of Examples 79 to 82, wherein the autoencoder is a variational autoencoder and the latent-space representation includes a mean and a standard deviation of a probability distribution.

Example 84 includes the non-transitory computer-readable medium of any of Examples 79 to 83, wherein the autoencoder is trained to reproduce data segments from a target signal class, and the classifier is configured to distinguish the data segments from the target signal class and data segments that are not from the target signal class based on separation of latent-space representations between the data segments from the target signal class and the data segments that are not from the target signal class.

Example 85 includes the non-transitory computer-readable medium of any of Examples 79 to 84, wherein the autoencoder is trained to reproduce speech data, and the classifier is configured to distinguish audio data segments that include speech from audio data segments that do not include speech.

Example 86 includes the non-transitory computer-readable medium of any of Examples 79 to 85, wherein the instructions further cause the one or more processors to provide input, based on the latent-space representation, to the generation network portion to generate a synthesized segment; and determine an error value based on comparison of the segment and the synthesized segment, wherein at least one of the one or more inputs provided to the classifier is based on the error value.

Example 87 includes the non-transitory computer-readable medium of Example 86, wherein determining the error value includes calculating an Itakura-Saito distance based on the segment and the synthesized segment.

Example 88 includes the non-transitory computer-readable medium of Example 86, wherein determining the error value includes calculating a scale-invariant signal-to-distortion ratio based on the segment and the synthesized segment.

Example 89 includes the non-transitory computer-readable medium of Example 86, wherein determining the error value includes calculating a log Spectral Distortion value based on the segment and the synthesized segment.

Example 90 includes the non-transitory computer-readable medium of any of Examples 79 to 89, wherein the instructions further cause the one or more processors to provide input, based on the latent-space representation, to the generation network portion to generate a probability distribution; and determine an error value based on the segment and the probability distribution, wherein at least one of the one or more inputs provided to the classifier is based on the error value.

Example 91 includes the non-transitory computer-readable medium of any of Examples 72 to 90, wherein at least one of the one or more inputs provided to the classifier includes the latent-space representation.

Example 92 includes the non-transitory computer-readable medium of any of Examples 72 to 91, wherein the instructions further cause the one or more processors to determine a divergence metric indicating differences between a probability distribution of the latent-space representation and an expected probability distribution, and wherein at least one of the one or more inputs provided to the classifier is based on the divergence metric.

Example 93 includes the non-transitory computer-readable medium of any of Examples 72 to 92, wherein the instructions further cause the one or more processors to determine a mode indicator associated with the segment, and wherein at least one of the one or more inputs provided to the classifier is based on the mode indicator.

Example 94 includes the non-transitory computer-readable medium of Example 93, wherein the mode indicator indicates whether the segment represents voiced speech.

Example 95 includes the non-transitory computer-readable medium of Example 93 or Example 94, wherein the mode indicator indicates whether the segment represents music.

Example 96 includes the non-transitory computer-readable medium of any of Examples 93 to 95, wherein the mode indicator is based on a statistical analysis of the time-series data.

Example 97 includes the non-transitory computer-readable medium of any of Examples 72 to 96, wherein the instructions further cause the one or more processors to determine one or more features associated with the segment, and wherein at least one of the one or more inputs provided to the classifier is based on the one or more features.

Example 98 includes the non-transitory computer-readable medium of Example 97, wherein the one or more features include one or more of open loop pitch, normalized correlation, spectral envelope, tonal stability, signal non-stationarity, linear prediction residual error, spectral difference, and spectral stationarity.

Example 99 includes the non-transitory computer-readable medium of any of Examples 72 to 98, wherein the instructions further cause the one or more processors to generate an Enhanced Variable Rate Codec (EVRC) mode decision based on the segment, and wherein at least one of the one or more inputs provided to the classifier is based on the EVRC mode decision.

Example 100 includes the non-transitory computer-readable medium of any of Examples 72 to 99, wherein the feature extractor includes a first machine-learning model that is trained, based on training data, to synthesize time-series data approximating input time-series data.

Example 101 includes the non-transitory computer-readable medium of Example 100, wherein each segment of the training data includes speech.

Example 102 includes the non-transitory computer-readable medium of Example 100, wherein the training data includes segments representing speech and segments representing non-speech sounds.

Example 103 includes the non-transitory computer-readable medium of Example 100, wherein each segment of the training data includes data assigned to a target signal class.

Example 104 includes the non-transitory computer-readable medium of Example 100, wherein the training data includes segments assigned to data assigned to a target signal class and data that are not assigned to the target signal class.

Example 105 includes the non-transitory computer-readable medium of any of Examples 100 to 104, wherein the classifier is trained using labeled training data that is based on outputs of the feature extractor.

Example 106 includes the non-transitory computer-readable medium of any of Examples 100 to 105, wherein the classifier includes a second machine-learning model, and wherein the first and second machine-learning models are jointly trained.

According to Example 107, an apparatus includes means for generating a latent-space representation of a segment of time-series data; means for providing one or more inputs to a classifier, the one or more inputs including at least one input based on the latent-space representation; and means for generating, based on output of the classifier, a processing control signal for the segment.

Example 108 includes the apparatus of Example 107, wherein the classifier is a one-class classifier or a binary classifier and the output indicates whether the segment is assigned to a target signal class.

Example 109 includes the apparatus of Example 107 or Example 108, further includes means for performing first encoding operations to encode the segment; means for performing second encoding operations to encode the segment; and means for selectively providing the segment to the means for performing the first encoding operations or to the means for performing the second encoding operations based on the processing control signal.

Example 110 includes the apparatus of any of Examples 107 to 109, wherein the time-series data represents audio content, and wherein the output indicates whether the segment includes an audio data type associated with a first audio encoder.

Example 111 includes the apparatus of any of Examples 107 to 110 and further includes means for selectively routing the segment to an audio encoder based on the processing control signal.

Example 112 includes the apparatus of any of Examples 107 to 111, wherein the segment corresponds to an audio frame including spectral representations of one or more audio data samples.

Example 113 includes the apparatus of any of Examples 107 to 112, wherein the feature extractor includes an inference network portion and generation network portion of an autoencoder.

Example 114 includes the apparatus of Example 113, wherein the autoencoder includes one or more recurrent layers.

Example 115 includes the apparatus of Example 113 or Example 114, wherein the autoencoder includes one or more dilated convolution layers.

Example 116 includes the apparatus of any of Examples 113 to 115, wherein the autoencoder includes one or more temporally dynamic layers.

Example 117 includes the apparatus of any of Examples 113 to 116, wherein the autoencoder is a variational autoencoder and the latent-space representation includes a mean and a standard deviation of a probability distribution.

Example 118 includes the apparatus of any of Examples 113 to 117, wherein the autoencoder is trained to reproduce data segments from a target signal class, and the classifier is configured to distinguish the data segments from the target signal class and data segments that are not from the target signal class based on separation of latent-space representations between the data segments from the target signal class and the data segments that are not from the target signal class.

Example 119 includes the apparatus of any of Examples 113 to 118, wherein the autoencoder is trained to reproduce speech data, and the classifier is configured to distinguish audio data segments that include speech from audio data segments that do not include speech.

Example 120 includes the apparatus of any of Examples 113 to 119, further includes means for providing input, based on the latent-space representation, to the generation network portion to generate a synthesized segment of time-series data; and means for determining an error value based on comparison of the segment and the synthesized segment, wherein at least one of the one or more inputs provided to the classifier is based on the error value.

Example 121 includes the apparatus of Example 120, wherein determining the error value includes calculating an Itakura-Saito distance based on the segment and the synthesized segment.

Example 122 includes the apparatus of Example 120, wherein determining the error value includes calculating a scale-invariant signal-to-distortion ratio based on the segment and the synthesized segment.

Example 123 includes the apparatus of Example 120, wherein determining the error value includes calculating a log Spectral Distortion value based on the segment and the synthesized segment.

Example 124 includes the apparatus of any of Examples 113 to 123, further includes means for providing input, based on the latent-space representation, to the generation network portion to generate a probability distribution; and means for determining an error value based on the segment and the probability distribution, wherein at least one of the one or more inputs provided to the classifier is based on the error value.

Example 125 includes the apparatus of any of Examples 107 to 124, wherein at least one of the one or more inputs provided to the classifier includes the latent-space representation.

Example 126 includes the apparatus of any of Examples 107 to 125 and further includes means for determining a divergence metric indicating differences between a probability distribution of the latent-space representation and an expected probability distribution, and wherein at least one of the one or more inputs provided to the classifier is based on the divergence metric.

Example 127 includes the apparatus of any of Examples 107 to 126 and further includes means for determining a mode indicator associated with the segment, and wherein at least one of the one or more inputs provided to the classifier is based on the mode indicator.

Example 128 includes the apparatus of Example 127, wherein the mode indicator indicates whether the segment represents voiced speech.

Example 129 includes the apparatus of Example 127 or Example 128, wherein the mode indicator indicates whether the segment represents music.

Example 130 includes the apparatus of any of Examples 127 to 129 and further includes means for performing a statistical analysis of the time-series data to generate the mode indicator.

Example 131 includes the apparatus of any of Examples 107 to 130 and further includes means for determining one or more features associated with the segment, and wherein at least one of the one or more inputs provided to the classifier is based on the one or more features.

Example 132 includes the apparatus of Example 131, wherein the one or more features include one or more of open loop pitch, normalized correlation, spectral envelope, tonal stability, signal non-stationarity, linear prediction residual error, spectral difference, and spectral stationarity.

Example 133 includes the apparatus of any of Examples 107 to 132 and further includes means for generating an Enhanced Variable Rate Codec (EVRC) mode decision based on the segment, and wherein at least one of the one or more inputs provided to the classifier is based on the EVRC mode decision.

Example 134 includes the apparatus of any of Examples 107 to 133, wherein the feature extractor includes a first machine-learning model that is trained, based on training data, to synthesize time-series data approximating input time-series data.

Example 135 includes the apparatus of Example 134, wherein each segment of the training data includes speech.

Example 136 includes the apparatus of Example 134, wherein the training data includes segments representing speech and segments representing non-speech sounds.

Example 137 includes the apparatus of Example 134, wherein each segment of the training data includes data assigned to a target signal class.

Example 138 includes the apparatus of Example 134, wherein the training data includes segments assigned to data assigned to a target signal class and data that are not assigned to the target signal class.

Example 139 includes the apparatus of any of Examples 134 to 138, wherein the classifier is trained using labeled training data that is based on outputs of the feature extractor.

Example 140 includes the apparatus of any of Examples 134 to 139, wherein the classifier includes a second machine-learning model, and wherein the first and second machine-learning models are jointly trained.

Those of skill would further appreciate that the various illustrative logical blocks, configurations, modules, circuits, and algorithm steps described in connection with the embodiments disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such embodiment decisions are not to be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
a memory configured to store one or more segments of time-series data; and
one or more processors configured to:
generate, using a feature extractor, a latent-space representation of a segment of the time-series data;
provide one or more inputs to a classifier, the one or more inputs including at least one input based on the latent-space representation; and
generate, based on output of the classifier, a processing control signal for the segment.

2. The device of claim 1, wherein the classifier is a one-class classifier or a binary classifier and the output indicates whether the segment is assigned to a target signal class.

3. The device of claim 2, wherein the one or more processors are configured to selectively, based on the processing control signal, perform first encoding operations to encode the segment or perform second encoding operations to encode the segment, wherein the first encoding operations provide higher quality encoding of the target signal class than do the second encoding operations.

4. The device of claim 2, wherein the one or more processors are configured to selectively, based on the processing control signal, perform first encoding operations to encode the segment or perform second encoding operations to encode the segment, wherein the first encoding operations provide more efficient encoding of the target signal class than do the second encoding operations.

5. The device of claim 1, wherein the time-series data represents audio content, and wherein the output indicates whether the segment includes an audio data type associated with a first audio encoder.

6. The device of claim 1, wherein the one or more processors are configured to selectively route the segment to one of two or more audio coders based on the processing control signal.

7. The device of claim 1, wherein the segment corresponds to a segment of audio data and the input to the feature extractor includes a frequency-domain representation of the segment of audio data.

8. The device of claim 7, wherein the frequency-domain representation includes a power spectrum of the segment of audio data.

9. The device of claim 1, wherein the feature extractor includes an inference network portion and generation network portion of an autoencoder.

10. The device of claim 9, wherein the autoencoder is a variational autoencoder and the latent-space representation includes a mean and a standard deviation of a probability distribution.

11. The device of claim 9, wherein the autoencoder is trained to reproduce data segments from a target signal class, and the classifier is configured to distinguish the data segments from the target signal class and data segments that are not from the target signal class based on separation of latent-space representations between the data segments from the target signal class and the data segments that are not from the target signal class.

12. The device of claim 9, wherein the autoencoder is trained to reproduce speech data and the classifier is configured to distinguish audio data segments that include speech from audio data segments that do not include speech.

13. The device of claim 9, wherein the one or more processors are configured to:
provide input, based on the latent-space representation, to the generation network portion to generate a synthesized segment of time-series data; and
determine a reconstruction error value based on comparison of the segment and the synthesized segment, wherein at least one of the one or more inputs provided to the classifier is based on the reconstruction error value.

14. The device of claim 9, wherein the one or more processors are configured to:
provide input, based on the latent-space representation, to the generation network portion to generate a probability distribution; and
determine an error value based on the segment and the probability distribution, wherein at least one of the one or more inputs provided to the classifier is based on the error value.

15. A method comprising:
generating, using a feature extractor, a latent-space representation of a segment of time-series data;
providing one or more inputs to a classifier, the one or more inputs including at least one input based on the latent-space representation; and
generating, based on output of the classifier, a processing control signal for the segment.

16. The method of claim 15, wherein the classifier is a one-class classifier or a binary classifier and the output indicates whether the segment is assigned to a target signal class.

17. The method of claim 16, further comprising selectively, based on the processing control signal, performing first encoding operations to encode the segment or performing second encoding operations to encode the segment, wherein the first encoding operations provide higher quality encoding of the target signal class than do the second encoding operations.

18. The method of claim 16, further comprising selectively, based on the processing control signal, performing first encoding operations to encode the segment or performing second encoding operations to encode the segment, wherein the first encoding operations provide more efficient encoding of the target signal class than do the second encoding operations.

19. The method of claim 15, wherein the time-series data represents audio content, and wherein the output indicates whether the segment includes an audio data type associated with a first audio encoder.

20. The method of claim 15, further comprising selectively routing the segment to an audio encoder based on the processing control signal.

21. The method of claim 15, wherein the segment corresponds to an audio frame including spectral representations of one or more audio data samples.

22. The method of claim 15, wherein the feature extractor includes an inference network portion and generation network portion of an autoencoder.

23. The method of claim 22, wherein the autoencoder is trained to reproduce data segments from a target signal class, and the classifier is configured to distinguish the data segments from the target signal class and data segments that are not from the target signal class.

24. The method of claim 23, wherein the autoencoder is trained to reproduce speech data, and the classifier is configured to distinguish audio data segments that include speech from audio data segments that do not include speech.

25. The method of claim 22, further comprising:
providing input, based on the latent-space representation, to the generation network portion to generate a synthesized segment of time-series data; and
determining an error value based on comparison of the segment and the synthesized segment, wherein at least one of the one or more inputs provided to the classifier is based on the error value.

26. The method of claim 22, further comprising:
providing input, based on the latent-space representation, to the generation network portion to generate a probability distribution; and
determining an error value based on the segment and the probability distribution, wherein at least one of the one or more inputs provided to the classifier is based on the error value.

27. The method of claim 15, further comprising determining a mode indicator associated with the segment, and wherein at least one of the one or more inputs provided to the classifier is based on the mode indicator.

28. A non-transitory computer-readable medium storing instructions that are executable by one or more processors to cause the one or more processors to:
generate, using a feature extractor, a latent-space representation of a segment of time-series data;
provide one or more inputs to a classifier, the one or more inputs including at least one input based on the latent-space representation; and
generate, based on output of the classifier, a processing control signal for the segment.

29. The non-transitory computer-readable medium of claim 28, wherein the feature extractor includes an inference network portion and generation network portion of an autoencoder, wherein the classifier is a one-class classifier or a binary classifier, and wherein the output indicates whether the segment is assigned to a target signal class.

30. An apparatus comprising:
means for generating a latent-space representation of a segment of time-series data;
means for providing one or more inputs to a classifier, the one or more inputs including at least one input based on the latent-space representation; and
means for generating, based on output of the classifier, a processing control signal for the segment.
